(19) United States
(12) Patent Application Publication
(10) Pub. No.: US 2023/0296996 A1
(43) Pub. Date: Sep. 21, 2023

(54) TONER, TONER-STORING UNIT, DEVELOPER, IMAGE FORMING APPARATUS, AND IMAGE FORMING METHOD

(71) Applicants: Yasuo Kamada, Shizuoka (JP); Takafumi Koyama, Shizuoka (JP); Tsuyoshi Nozaki, Shizuoka (JP); Shun Matsuura, Shizuoka (JP)

(72) Inventors: Yasuo Kamada, Shizuoka (JP); Takafumi Koyama, Shizuoka (JP); Tsuyoshi Nozaki, Shizuoka (JP); Shun Matsuura, Shizuoka (JP)

(73) Assignee: Ricoh Company, Ltd., Tokyo (JP)

(21) Appl. No.: 18/180,766

(22) Filed: Mar. 8, 2023

(30) Foreign Application Priority Data
Mar. 18, 2022 (JP) 2022-043606
Nov. 29, 2022 (JP) 2022-190591

(51) Int. Cl. G03G 9/087; G03G 15/08; G03G 9/093

(52) U.S. Cl. CPC G03G 9/08755; G03G 15/0865; G03G 9/09342; G03G 9/09371

(57) ABSTRACT

A toner includes toner base and an external additive containing silica. The toner base includes binder resin, colorant, release agent, and modified layered inorganic mineral that is obtained by modifying, with an organic ion, part of ions between layers in layered inorganic mineral. An amount of the modified layered inorganic mineral is 0.1 parts by mass or more and less than 1.4 parts by mass relative to 100 parts by mass of the toner. Liberation ratio A (% by mass) of silica from the toner satisfies relation (1): 0.5≤A≤1.0. The binder resin includes a component insoluble in THF and a component soluble in THF. The component insoluble in THF has two glass transition temperatures of Tga1st and Tgb1st at first temperature rise in DSC. The Tga1st is −40° C. or more and 10° C. or less. The Tgb1st is 45° C. or more and 65° C. or less.

### CROSS-REFERENCE TO RELATED APPLICATIONS

The present application claims priority under 35 U.S.C. § 119 to Japanese Patent Application No. 2022-043606, filed Mar. 18, 2022 and Japanese Patent Application No. 2022-190591, filed Nov. 29, 2022. The contents of which are incorporated herein by reference in their entirety.

### BACKGROUND OF THE INVENTION

### 1. Field of the Invention

The disclosures herein generally relate to a toner, a toner-storing unit, a developer, an image forming apparatus, and an image forming method.

### 2. Description of the Related Art

In recent years, toners have been required to have a small particle diameter for improving the quality of output images, high-temperature offset resistance, low temperature fixability for energy saving, and heat-resistant storage stability capable of withstanding high-temperature and high-humidity during storage or transportation after production. In particular, since the power consumption at the time of fixing accounts for most of the power consumption in an image forming process, it is very important to improve the low temperature fixability.

Conventionally, toners produced by the kneading-pulverization method have been used. However, the toner produced by the kneading-pulverization method has problems in which the particle diameter of the toner is difficult to reduce, the quality of output images is insufficient due to the irregular shape of the toner and broad distribution of particle diameters, and the energy required for fixing is large. In addition, when a wax (release agent) is added in order to improve the fixability, the toner produced by the kneading-pulverization method cracks at the interface with the wax during pulverization, resulting in appearance of a large amount of the wax on the surface of the toner. Therefore, although the release effect is achieved, there are problems in which the toner is more likely to adhere to a carrier, a photoconductor, and a blade (filming) and the overall performance is unsatisfactory.

In order to overcome the problems of the kneading-pulverization method, toner production methods using the polymerization method have been proposed. The toner produced by the polymerization method has a smaller particle diameter, has sharper particle size distribution than the toner produced by the kneading-pulverization method, and can further include the release agent inside the toner. As the toner production method using the polymerization method, for the purpose of improvement of low-temperature fixability and improvement of high temperature offset resistance, the method of producing a toner from a reaction product obtained by elongating a urethane-modified polyester as a toner binder has been proposed (for example, see Japanese Unexamined Patent Application Publication No. 11-133665).

Moreover, there have been methods of producing a toner that is excellent in powder flowability and transferability when the toner has a small particle diameter, and is also excellent in heat-resistant storage stability, low-temperature fixability, and high temperature offset resistance (see, for example, Japanese Unexamined Patent Application Publication No. 2002-287400 and Japanese Unexamined Patent Application Publication No. 2002-351143). In addition, the method of producing a toner, which includes a step of producing a toner binder having a stable molecular weight distribution and an aging step in order to achieve low-temperature fixability and high temperature offset resistance, has been disclosed (see, for example, Japanese Patent No. 2579150 and Japanese Unexamined Patent Application Publication No. 2001-158819).

However, the aforementioned techniques do not satisfy a high level of low-temperature fixability required in recent years.

Therefore, in order to obtain a high level of low-temperature fixability, a toner, which includes a resin including a crystalline polyester resin, and a release agent, and has a sea-island phase separation structure where the resin and the wax are incompatible with each other, has been proposed (see, for example, Japanese Unexamined Patent Application Publication No. 2004-46095). A toner that includes a crystalline polyester resin, a release agent, and a graft polymer has been proposed (see, for example, Japanese Unexamined Patent Application Publication No. 2007-271789).

In addition, a toner, which includes certain polyester resins A and B and crystalline polyester resin C, and is excellent in low-temperature fixability, heat-resistant storage stability, and storage ability at high temperature and high humidity, has been proposed (see, for example, Japanese Unexamined Patent Application Publication No. 2015-52697, Japanese Unexamined Patent Application Publication No. 2015-118151, Japanese Unexamined Patent Application Publication No. 2016-164616, and Japanese Patent No. 5884797).

### SUMMARY OF THE INVENTION

In one embodiment, a toner for developing an electrostatic charge image is provided. The toner includes: a toner base; and an external additive containing silica. The toner base includes at least a binder resin, a colorant, a release agent, and a modified layered inorganic mineral. The modified layered inorganic mineral is obtained by modifying, with an organic ion, at least part of ions between layers in a layered inorganic mineral. An amount of the modified layered inorganic mineral is 0.1 parts by mass or more and less than 1.4 parts by mass relative to 100 parts by mass of the toner. A liberation ratio A of silica from the toner, represented by % by mass, satisfies a relation (1) below: 0.5≤A≤1.0 . . . relation (1). The binder resin includes a component insoluble in tetrahydrofuran (THF) and a component soluble in THF. The component insoluble in THF has two glass transition temperatures of Tga1st and Tgb1st at a first temperature rise in differential scanning calorimetry (DSC). The Tga1st is −40° C. or more and 10° C. or less, and the Tgb1st is 45° C. or more and 65° C. or less.

### BRIEF DESCRIPTION OF THE DRAWINGS

FIG. 1 is a view for describing the way of determining Tg in a DSC curve;

FIG. 2 is a schematic view illustrating one example of an image forming apparatus according to the present disclosure; and

FIG. 3 is a schematic view illustrating one example of a process cartridge.

### DESCRIPTION OF THE PREFERRED EMBODIMENTS

In the following, embodiments of the present invention will be described with reference to the accompanying drawings.

In the techniques described in Japanese Unexamined Patent Application Publication Nos. 2004-46095, 2007-271789, 2015-52697, 2015-118151, and 2016-164616, and Japanese Patent No. 5884797, a crystalline polyester resin melts more rapidly compared to a polyester resin, resulting in achievement of low-temperature fixability. However, when a toner includes a crystalline polyester resin, there is a problem in which aggregations of the toner are caused in high temperature and high humidity environments. Moreover, in recent years, there are problems (paper ejection blocking) in which when the toner is fixed on paper and sheets of the paper are stacked in a paper ejection tray, the toner and the paper become attached due to the pressure caused by the weight of the sheets of paper and the remaining heat at the time of fixing, and problems such as poor images (roughness) due to deterioration of the toner caused when the toner experiences stress in a developing device.

Moreover, toners recently used in printing systems working at ultra-high speeds are required to continuously output images with certain image qualities even when exposed to severe service conditions, such as variations in temperatures and humidities in an environment where an image forming apparatus is used and continuous output of large amounts of images, and are required to handle any kind of paper because various kinds of paper are used.

An object of the present disclosure is to provide a toner that can achieve low-temperature fixability and heat-resistant storage stability, has excellent drum cleanability, and can minimize roughness or filming of an additive.

According to the present disclosure, it is possible to provide a toner that can achieve low-temperature fixability and heat-resistant storage stability, has excellent drum cleanability, and can minimize roughness or filming of an additive.

Hereinafter, a toner, a toner-storing unit, a developer, an image forming apparatus, and an image forming method according to the present disclosure will be described with reference to the drawings. It should be noted that the present disclosure is not limited to the embodiments described below, and changes such as other embodiments, additions, modifications, and deletions can be made within the scope conceivable by persons skilled in the art. Any aspect shall be included in the scope of the present disclosure as long as the actions and effects of the present disclosure are exhibited.

(Toner)

The toner of the present disclosure is a toner for developing an electrostatic charge image, which includes a toner base; and an external additive containing silica.

The toner base includes at least a binder resin, a colorant, a release agent, and a modified layered inorganic mineral, the modified layered inorganic mineral being obtained by modifying, with an organic ion, at least part of ions between layers in a layered inorganic mineral. An amount of the modified layered inorganic mineral is 0.1 parts by mass or more and less than 1.4 parts by mass relative to 100 parts by mass of the toner.

A liberation ratio A (% by mass) of silica from the toner satisfies a relation (1) below. The binder resin includes a component insoluble in tetrahydrofuran (THF) and a component soluble in THF. The component insoluble in THF has two glass transition temperatures of Tga1st and Tgb1st at a first temperature rise in differential scanning calorimetry (DSC). The Tga1st is −40° C. or more and 10° C. or less, and the Tgb1st is 45° C. or more and 65° C. or less.

0.5≤A≤1.0 (1)

The component insoluble in THF is preferably a polyester resin.

The component insoluble in THF has two glass transition temperatures of Tga1st and Tgb1st at a first temperature rise in DSC. A component contributing to the glass transition temperature of Tga1st is considered as polyester resin A, and a component contributing to the glass transition temperature of Tgb1st is considered as polyester resin B.

A component contributing to the glass transition temperature (Tgc2nd) of the component soluble in THF in the toner at a second temperature rise in DSC is considered as polyester resin C.

The polyester resin A and the polyester resin B are mainly components derived from polyester resins having a weight average molecular weight (Mw) of from 100,000 through 200,000. The polyester resin C soluble in THF is mainly a component derived from a polyester resin having a weight average molecular weight (Mw) of from 3,000 through 10,000.

The glass transition temperatures in the present disclosure are defined as follows.

Tg1st: The glass transition temperature of the toner at the first temperature rise

Tg2nd: The glass transition temperature of the toner at the second temperature rise

Tga1st: The glass transition temperature of the component insoluble in THF in the toner at the first temperature rise

Tgb1st: The glass transition temperature of the component insoluble in THF in the toner at the first temperature rise

Tga2nd: The glass transition temperature of the component insoluble in THF in the toner at the second temperature rise

Tgb2nd: The glass transition temperature of the component insoluble in THF in the toner at the second temperature rise

Tgab2nd: The glass transition temperature of the component (mixed component) insoluble in THF in the toner at the second temperature rise

Tgc2nd: The glass transition temperature of the component soluble in THF in the toner at the second temperature rise

Regarding the melting points and the glass transition temperatures Tg of the other constituent components such as the polyester resins A, B, and C and the release agent, unless otherwise specified, an endothermic peak top temperature and a glass transition temperature Tg2nd at the second temperature rise are regarded as a melting point and a glass transition temperature Tg of each target sample.

The polyester resin A imparts plasticity to the toner. The polyester resin A insoluble in tetrahydrofuran (THF) decreases Tg or melt viscosity and exhibits low-temperature fixability while the resulting toner has such rubber-like properties that it deforms at lower temperatures but does not flow. The reason for this is because the polyester resin A insoluble in tetrahydrofuran (THF) has a branched structure in its molecular skeleton and the molecular chain forms a three-dimensional network structure.

The conventional technique (for example, Japanese Unexamined Patent Application Publication No. 2015-52697) has solved the problems by optimizing a ratio between the polyester resin A and the polyester resin C. However, when the amount of the polyester resin A is too large, the Tg decreases, and therefore the storage ability cannot be ensured. In addition, the resistance to stress of the toner is deteriorated, and the fluidizing agent or the like on the surface of the toner is embedded due to thermal mechanical stress applied by stirring in a developing device, resulting in a large adhesion force of toner particles. As a result, there is a concern that failures such as image roughness may occur in the transfer process. On the other hand, the amount of the polyester resin A is too small, the plasticity is insufficiently imparted, and the low-temperature fixability cannot be satisfied. Moreover, there are concerns that necessary elasticity is not imparted thereby deteriorating high-temperature offset, narrowing the fixable region, and producing image that are glossy.

The present disclosure uses, in combination, the polyester resin B, which imparts elasticity and has a Tg that is not greatly deviated from that of the toner; i.e., the Tg of the polyester resin B is substantially equal to that of the toner. As a result, it is possible to increase the elasticity of the toner without affecting the heat resistance, to ensure the offset region, to decrease image roughness, and to control the image glossiness within appropriate ranges.

<Component Insoluble in THF>

<<Polyester Resin A>>

The polyester resin A is a resin insoluble in tetrahydrofuran (THF).

The polyester resin A preferably includes, as constituent components, a polyhydric alcohol component and a polycarboxylic acid component. Preferable examples of the polyhydric alcohol component include diol components.

Examples of the diol component include aliphatic diols having from 3 through 10 carbon atoms. Examples of the aliphatic diol having from 3 through 10 carbon atoms include 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol.

The amount of the aliphatic diol having from 3 through 10 carbon atoms is preferably 50% by mole or more, and more preferably 80% by mole or more, relative to the total amount of the polyester resin A.

The diol component of the polyester resin A preferably includes: a part having an odd number of carbon atoms ranging from 3 to 9 at a main chain; and an alkyl group at a side chain, and is more preferably a structure represented by the following Formula (1).

HO—(CR¹R²)n—OH Formula (1)

In the Formula, R¹ and R² each independently represent hydrogen or an alkyl group having from 1 through 3 carbon atoms. n represents an odd number of from 3 through 9. In n repeating units, R¹ and R² may be identical to or different from each other.

The polyester resin A preferably includes a crosslinking component. The polyester resin A preferably includes a trihydric or higher aliphatic alcohol component as the crosslinking component, and more preferably includes a trihydric or tetrahydric aliphatic alcohol component as the crosslinking component in terms of the glossiness and the image density of fixed images. The trihydric or tetrahydric aliphatic alcohol component is preferably an aliphatic polyhydric alcohol component that is trihydric or tetrahydric and has from 3 through 10 carbon atoms. The crosslinking component may be only the trihydric or higher aliphatic alcohol.

The trihydric or higher aliphatic alcohol may be appropriately selected in accordance with the intended purpose. Examples thereof include glycerin, trimethylolethane, trimethylolpropane, pentaerythritol, sorbitol, and dipentaerythritol. These trihydric or higher aliphatic alcohols may be used alone or in combination.

As the crosslinking component of the polyester resin A, for example, trivalent or higher carboxylic acids or epoxy compounds may be used. However, the trihydric or higher aliphatic alcohol as the crosslinking component is preferably included because unevenness does not easily occur, and sufficient glossiness or sufficient image density can be obtained.

The rate of the crosslinking component in the constituent component of the polyester resin A is not particularly limited and may be appropriately selected in accordance with the intended purpose. The rate thereof is preferably 0.5% by mass or more and 5% by mass or less, and more preferably 1% by mass or more and 3% by mass or less.

The rate of the trihydric or higher aliphatic alcohol in the polyhydric alcohol component that is the constituent component of the polyester resin A is not particularly limited and may be appropriately selected in accordance with the intended purpose. The rate thereof is preferably 50% by mass or more and 100% by mass or less, and more preferably 90% by mass or more and 100% by mass or less.

The dicarboxylic acid component of the polyester resin A includes aliphatic dicarboxylic acid having from 4 through 12 carbon atoms, and preferably includes 50% by mole or more of the aliphatic dicarboxylic acid having from 4 through 12 carbon atoms.

Examples of the aliphatic dicarboxylic acid having from 4 through 12 carbon atoms include succinic acid, glutaric acid, adipic acid, pimelic acid, suberic acid, azelaic acid, sebacic acid, and dodecanedioic acid.

The polyester resin A preferably include either or both of a urethane bond and a urea bond because adhesiveness to a recording medium such as paper is more excellent. As a result, the urethane bond or urea bond exhibits behavior like the pseudo-crosslinking point, the rubber-like property of the polyester resin A increases, and the heat-resistant storage stability and the high temperature offset resistance of the toner are more excellent.

The molecular weight of the polyester resin A is not particularly limited and may be appropriately selected in accordance with the intended purpose.

As the molecular weight of the polyester resin A, the weight average molecular weight (Mw) measured through gel permeation chromatography (GPC) is preferably from 100,000 through 200,000. When the molecular weight of the polyester resin A falls within the aforementioned range, it is possible to overcome problems in which the heat-resistant storage stability of the toner and the durability against stress such as stirring in a developing device are deteriorated, or to overcome problems in which the viscoelasticity at the time of melting the toner increases to deteriorate the low-temperature fixability, which is suitable.

The Tga2nd of the polyester resin A is preferably −50° C. or more and 0° C. or less, and more preferably −40° C. or more and −20° C. or less.

When the Tga2nd of the polyester resin A is −50° C. or more, it is possible to overcome problems in which the heat-resistant storage stability of the toner and the durability against stress such as stirring in a developing device are deteriorated and the filming resistance is deteriorated, which is suitable. On the other hand, when the Tga2nd of the polyester resin A is 0° C. or less, it is possible to overcome problems in which the toner is insufficiently deformed through heating and pressurization at the time of fixing and the low-temperature fixability is insufficient, which is suitable.

<<Polyester Resin B>>

The polyester resin B is a resin insoluble in tetrahydrofuran (THF).

The polyester resin B preferably includes a polyhydric alcohol component and a polycarboxylic acid component. Moreover, the polyester resin B is preferably a modified polyester including an ester bond and a bond unit other than the ester bond, and a binder resin precursor is preferably a resin precursor that can form the modified polyester.

Examples of the polyhydric alcohol component in the polyester resin B include: alkylene glycols (e.g., ethylene glycol, 1,2-propylene glycol, 1,3-propylene glycol, 1,4-butanediol, and 1,6-hexanediol); alkylene ether glycols (e.g., diethylene glycol, triethylene glycol, dipropylene glycol, polyethylene glycol, polypropylene glycol, and polytetramethylene ether glycol); alicyclic diols (e.g., 1,4-cyclohexanedimethanol and hydrogenated bisphenol A); bisphenols (e.g., bisphenol A, bisphenol F, and bisphenol S); alkylene oxides (e.g., ethylene oxide, propylene oxide, and butylene oxide) adducts of the alicyclic diols; and alkylene oxide (e.g., ethylene oxide, propylene oxide, and butylene oxide) adducts of the bisphenols. These may be used alone or in combination. Among them, alkylene glycols having from 2 through 12 carbon atoms and alkylene oxide adducts of bisphenols (e.g., bisphenol A ethylene oxide 2 mol adduct, bisphenol A propylene oxide 2 mol adduct, and bisphenol A propylene oxide 3 mol adduct) are preferable.

Examples of a trihydric or higher polyol in the polyester resin B include: polyhydric aliphatic alcohols (e.g., glycerin, trimethylolethane, trimethylolpropane, pentaerythritol, and sorbitol); trivalent or higher phenols (phenol novolak and cresol novolak); and alkylene oxide adducts of trivalent or higher polyphenols. These may be used in combination.

Examples of a bivalent carboxylic acid component in the polyester resin B include: alkylene dicarboxylic acids (e.g., succinic acid, adipic acid, and sebacic acid); alkenylene dicarboxylic acids (e.g., maleic acid and fumaric acid); and aromatic dicarboxylic acids (e.g., terephthalic acid, isophthalic acid, and naphthalene dicarboxylic acid). These may be used in combination. Among them, alkenylene dicarboxylic acids having from 4 through carbon atoms and aromatic dicarboxylic acids having from 8 through 20 carbon atoms are preferable.

Examples of trivalent or higher polycarboxylic acid in the polyester resin B include aromatic polycarboxylic acids having from 9 through carbon atoms (e.g., trimellitic acid and pyromellitic acid). These may be used in combination.

Instead of the polycarboxylic acid, anhydrides of polycarboxylic acid or lower alkyl esters (e.g., methyl ester, ethyl ester, and isopropyl ester) may be used.

Moreover, the polyester resin B preferably includes either or both of a urethane bond and a urea bond because adhesiveness to a recording medium such as paper is more excellent. As a result, the urethane bond or urea bond exhibits behavior like the pseudo-crosslinking point, the rubber-like property of the polyester resin B increases, and the heat-resistant storage stability and the high temperature offset resistance of the toner are more excellent.

The Tgb2nd Tgb2nd of the polyester resin B is preferably from 45° C. through 65° C., and more preferably from 50° C. through 60° C.

When the Tgb2nd of the polyester resin B is 45° C. or more, it is possible to overcome problems in which the heat-resistant storage stability of the toner and the durability against stress such as stirring in a developing device are deteriorated and the filming resistance is deteriorated, which is suitable. On the other hand, the Tgb2nd of the polyester resin B is 65° C. or less, it is possible to overcome problems in which the toner is insufficiently deformed through heating and pressurization at the time of fixing and the low-temperature fixability is insufficient, which is suitable.

<Component Soluble in THF>

<<Polyester Resin C>>

The polyester resin C is a resin soluble in tetrahydrofuran (THF).

The polyester resin C preferably includes a diol component and a dicarboxylic acid component as constituent components, components, and preferably includes 40% by mole or more of the alkylene glycol. The polyester resin C may include or may not include a crosslinking component as a constituent component.

The polyester resin C is preferably a linear polyester resin.

The polyester resin C is preferably an unmodified polyester resin. The unmodified polyester resin is a polyester resin, which is obtained by using a polyhydric alcohol or polycarboxylic acid (e.g., polycarboxylic acid, polycarboxylic acid anhydride, and polycarboxylate) or the derivative thereof and is not modified with, for example, an isocyanate compound.

Examples of the polyhydric alcohol in the polyester resin C include diols.

Examples of the diol include: alkylene (number of carbon atoms: 2 to 3) oxide (average number of moles added: 1 to 10) adducts of bisphenol A, such as polyoxypropylene (2.2)-2,2-bis(4-hydroxyphenyl) propane and polyoxyethylene (2.2)-2,2-bis(4-hydroxyphenyl) propane; ethylene glycol; propylene glycol; hydrogenated bisphenol A; and alkylene (number of carbon atoms: 2 to 3) oxide (average number of moles added: 1 to 10) adducts of hydrogenated bisphenol A.

These may be used alone or in combination.

Examples of the polycarboxylic acid in the polyester resin C include dicarboxylic acid.

Examples of the dicarboxylic acid include adipic acid, phthalic acid, isophthalic acid, terephthalic acid, fumaric acid, maleic acid, and succinic acids substituted with an alkyl group having from 1 through 20 carbon atoms or an alkenyl group having from 2 through 20 carbon atoms, such as dodecenylsuccinic acid and octylsuccinic acid. Particularly, 50% by mole or more of terephthalic acid is preferably included.

These may be used alone or in combination.

In order to adjust the acid value and the hydroxyl value, the polyester resin C may include trivalent or higher carboxylic acid and/or trihydric or higher alcohol at the terminal of its resin chain.

Examples of the trivalent or higher carboxylic acid in the polyester resin C include trimellitic acid, pyromellitic acid, and acid anhydrides thereof.

Examples of the trihydric or higher alcohol in the polyester resin C include glycerin, pentaerythritol, and trimethylolpropane.

The polyester resin C preferably includes a crosslinking component. The polyester resin C preferably includes trihydric or higher aliphatic alcohol as the crosslinking component, and more preferably includes trihydric or tetrahydric aliphatic alcohol in terms of the glossiness and the image density of fixed images. The trihydric or tetrahydric aliphatic alcohol is preferably an aliphatic polyhydric alcohol component that is trihydric or tetrahydric and has from 3 through 10 carbon atoms. The crosslinking component may be only the trihydric or higher aliphatic alcohol.

The trihydric or higher aliphatic alcohol in the polyester resin C may be appropriately selected in accordance with the intended purpose. Examples thereof include glycerin, trimethylolethane, trimethylolpropane, pentaerythritol, sorbitol, and dipentaerythritol. These trihydric or higher aliphatic alcohols may be used alone or in combination.

As the crosslinking component of the polyester resin C, for example, trivalent or higher carboxylic acids or epoxy compounds may be used. However, the trihydric or higher aliphatic alcohol as the crosslinking component is preferably included because unevenness does not easily occur, and sufficient glossiness or sufficient image density can be obtained.

The molecular weight of the polyester resin C is not particularly limited and may be appropriately selected in accordance with the intended purpose. As the molecular weight of the polyester resin C, the weight average molecular weight (Mw) measured through gel permeation chromatography (GPC) is preferably from 3,000 through 10,000, and the number average molecular weight (Mn) measured through gel permeation chromatography (GPC) is preferably from 1,000 through 4,000. In addition, the Mw/Mn is preferably from 1.0 through 4.0. The weight average molecular weight (Mw) is more preferably from 4,000 through 7,000, the number average molecular weight (Mn) is more preferably 1,500 through 3,000, and the Mw/Mn is more preferably 1.0 through 3.5.

When the molecular weight of the polyester resin C falls within the aforementioned range, it is possible to overcome problems in which the heat-resistant storage stability of the toner and the durability against stress such as stirring in a developing device are deteriorated, or to overcome problems in which the viscoelasticity at the time of melting the toner increases to deteriorate the low-temperature fixability, which is suitable.

The amount of a component having a molecular weight of the THF-soluble component of 600 or less is preferably from 2% by mass through 10% by mass. The polyester resin C may be extracted with methanol, and the component having a molecular weight of the THF-soluble component of 600 or less may be removed and purified. When the component having a molecular weight of the THF-soluble component of 600 or less falls within the aforementioned range, it is possible to overcome problems in which the heat-resistant storage stability of the toner and the durability against stress such as stirring in a developing device are deteriorated, or to overcome a problem in which the low-temperature fixability is deteriorated, which is suitable.

The acid value of the polyester resin C is not particularly limited and may be appropriately selected in accordance with the intended purpose. The acid value thereof is preferably from 1 mg KOH/g through 50 mg KOH/g, and more preferably from 5 mg KOH/g through 30 mg KOH/g.

When the acid value of the polyester resin C is 1 mg KOH/g or more, the toner is easily negatively charged, and affinity between paper and the toner becomes better at the time of fixing the toner to the paper. This makes it possible to improve the low-temperature fixability. When the acid value of the polyester resin C is 50 mg KOH/g or less, it is possible to overcome a problem in which charging stability, particularly charging stability under environmental variations decreases, which is suitable.

The hydroxyl value of the polyester resin C is not particularly limited and may be appropriately selected in accordance with the intended purpose. The hydroxyl value thereof is preferably 5 mg KOH/g or more.

The Tgc2nd of the polyester resin C is preferably 45° C. or more and 65° C. or less, and more preferably 50° C. or more and 60° C. or less.

When the Tgc2nd of the polyester resin C falls within the aforementioned range, it is possible to overcome problems in which the heat-resistant storage stability of the toner and the durability against stress such as stirring in a developing device are deteriorated and the filming resistance is deteriorated, or to overcome problems in which the toner is insufficiently deformed through heating and pressurization at the time of fixing and the low-temperature fixability is insufficient, which is suitable.

The amount of the polyester resin C is preferably 80 parts by mass or more and 90 parts by mass or less, and more preferably 80 parts by mass or more and 85 parts by mass or less, relative to 100 parts by mass of the toner.

In the case of a three-component system including the polyester resin A, the polyester resin B, and the polyester resin C, although the reason is unclear, when the polyester resin A, the polyester resin B, and the polyester resin C are mixed at any ratio, the resins are separated, and poor dispersion of pigments occurs, which may decrease a degree of coloring. However, when the amount of the polyester resin C is 80 parts by mass or more, the fixing region⋅storage ability can be ensured without decreasing a degree of coloring, and the aforementioned problems can be solved.

<<Polyester Resin Having Either or Both of Urethane Bond and Urea Bond>>

The polyester resin having either or both of a urethane bond and a urea bond is not particularly limited and may be appropriately selected in in accordance with the intended purpose. Examples thereof include a reaction product include a reaction product obtained by reacting a polyester resin having an active hydrogen group with polyisocyanate. This reaction product is preferably used as a reaction precursor (may be referred to as “prepolymer”) reacted with a curing agent that will be described hereinafter.

Examples of the polyester resin having an active hydrogen group include a polyester resin having a hydroxyl group.

—Polyisocyanate—

The polyisocyanate is not particularly limited and may be appropriately selected in accordance with the intended purpose. Examples thereof include diisocyanate and trivalent or higher isocyanate.

Examples of the diisocyanate include aliphatic diisocyanate, alicyclic diisocyanate, aromatic diisocyanate, aromatic aliphatic diisocyanate, isocyanurates, and those obtained by blocking the aforementioned compounds with, for example, phenol derivatives, oxime, or caprolactam.

Examples of the aliphatic diisocyanate include tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, and tetramethylhexane diisocyanate.

Examples of the alicyclic diisocyanate include isophorone diisocyanate and cyclohexylmethane diisocyanate.

Examples of the aromatic diisocyanate include tolylene diisocyanate, diisocyanatodiphenylmethane, 1,5-naphthylenediisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenylether.

Examples of the aromatic aliphatic diisocyanate include α,α,α′,α′-tetramethylxylylene diisocyanate.

Examples of the isocyanurates include tris(isocyanatoalkyl)isocyanurate and tris(isocyanatocycloalkyl)isocyanurate. These polyisocyanates may be used alone or in combination.

—Curing Agent—

The curing agent is not particularly limited and may be appropriately selected in accordance with the intended purpose, as long as it can react with a prepolymer. Examples thereof include active hydrogen group-containing compounds.

—Active Hydrogen Group-Containing Compound—

The active hydrogen group in the active hydrogen group-containing compound is not particularly limited and may be appropriately selected in accordance with the intended purpose. Examples thereof include hydroxyl groups (alcoholic hydroxyl group and phenolic hydroxyl group), amino groups, carboxyl groups, and mercapto groups. These may be used alone or in combination.

Preferable examples of the active hydrogen group-containing compound include amines because the urea bond can be formed.

Examples of the amines include diamine, trivalent or higher amine, amino alcohol, amino mercaptan, amino acid, and compounds obtained by blocking these amino groups. These may be used alone or in combination.

Among them, diamine, or a mixture of diamine and a small amount of trivalent or higher amine is preferable.

Examples of the diamine include aromatic diamine, alicyclic diamine, and aliphatic diamine.

Examples of the aromatic diamine include phenylenediamine, diethyltoluene diamine, and 4,4′-diaminodiphenylmethane.

Examples of the alicyclic diamine include 4,4′-diamino-3,3′-dimethyldicyclohexylmethane, diaminocyclohexane, and isophoronediamine.

Examples of the aliphatic diamine include ethylene diamine, tetramethylene diamine, and hexamethylenediamine.

Examples of the trivalent or higher amine include diethylenetriamine and triethylenetetramine.

Examples of the amino alcohol include ethanolamine and hydroxyethylaniline.

Examples of the amino mercaptan include aminoethyl mercaptan and aminopropyl mercaptan.

Examples of the amino acid include aminopropionic acid and aminocaproic acid.

Examples of the compound obtained by blocking amino group include ketimine compounds and oxazoline compounds, which are obtained by blocking an amino group with ketones such as acetone, methyl ethyl ketone, and methyl isobutyl ketone.

The molecular structures of the polyester resins A, B, and C can be confirmed through, for example, the X-ray diffraction, GC/MS, LC/MS, or IR measurement in addition to the solution or solid NMR measurement. In a simple manner, a method, in which one having no absorption based on δCH (out-of-plane bending vibration) of olefin at 965±10 cm⁻¹ or 990±10 cm⁻¹ in infrared absorption spectroscopy is detected as the polyester resin, can be exemplified.

<Release Agent>

The release agent is not particularly limited and may be appropriately selected from conventional release agents.

Examples of the release agents of the waxes include natural waxes: such as plant-based waxes (e.g., carnauba wax, cotton wax, Japan wax, and rice wax); animal-based waxes (e.g., beeswax and lanolin); mineral-based waxes (e.g., ozocerite and ceresin); and petroleum-based waxes (e.g., paraffin, microcrystalline, and petrolatum).

In addition to these natural waxes, examples of the waxes include: synthetic hydrocarbon waxes such as Fischer-Tropsch wax, polyethylene, and polypropylene; and synthetic waxes such as ester, ketone, and ether.

Furthermore, fatty acid amide-based compounds such as 12-hydroxystearic acid amide, stearic acid amide, phthalic anhydride imide, and chlorinated hydrocarbons; homopolymers or copolymers of polyacrylates such as poly-n-stearyl methacrylate and poly-n-lauryl methacrylate (e.g., a copolymer of n-stearyl acrylate and ethyl methacrylate), which are low-molecular-weight crystalline polymer resins; and crystalline polymers having a long alkyl group in a side chain may be used. Among them, hydrocarbon-based waxes such as paraffin wax, microcrystalline wax, Fischer-Tropsch wax, polyethylene wax, and polypropylene wax are preferable.

The melting point of the release agent is not particularly limited and may be appropriately selected in accordance with the intended purpose. The melting point thereof is preferably from 60° C. through 80° C.

When the melting point of the release agent is 60° C. or more, it is possible to overcome problems in which the release agent melts easily at low temperatures and the heat-resistant storage stability is deteriorated, which is suitable. When the melting point of the release agent is 80° C. or less, it is possible to overcome problems in which the release agent does not melt sufficiently to cause fixing offset, and defected images are formed even when the resin melts and falls in the fixing temperature region, which is suitable.

The amount of the release agent is not particularly limited and may be appropriately selected in accordance with the intended purpose. The amount thereof is preferably 2 parts by mass or more and 10 parts by mass or less, and more preferably 3 parts by mass or more and 8 parts by mass or less, relative to 100 parts by mass of the toner.

When the amount of the release agent is 2 parts by mass or more, it is possible to overcome problems in which the high temperature offset resistance and the low-temperature fixability are deteriorated at the time of fixing, which is suitable. When the amount of the release agent is 10 parts by mass or less, it is possible to overcome problems in which the heat storage stability decreases and fog of images is caused, which is suitable. The amount of the release agent falling within the more preferable range is advantageous in terms of improvement in image quality and fixing stability.

<Colorant>

The colorant is not particularly limited and may be appropriately selected in accordance with the intended purpose. Examples thereof include carbon black, nigrosine dyes, iron black, naphtol yellow S, Hansa yellow (10G, 5G, G), cadmium yellow, yellow iron oxide, ocher, chrome yellow, titan yellow, polyazo yellow, oil yellow, hansa yellow (GR, A, RN, R), pigment yellow L, benzidine yellow (G, GR), permanent yellow (NCG), balkanfast yellow (5G, R), tartrazine lake, quinoline yellow lake, anthrazan yellow BGL, BGL, isoindolinone yellow, red iron oxide, red lead, Shuen, cadmium red, cadmium mercury red, antimony vermilion, permanent red 4R, para red, fire red, para-chloro-ortho nitroaniline red, lithol fast scarlet G, brilliant fast scarlet, brilliant carmine BS, permanent red (F2R, F4R, FRL, FRLL, F4RH), fast scarlet VD, vulcan fast rubin B, brilliant scarlet G, lithol rubin GX, permanent red FSR, brilliant carmine 6B, pigment scarlet 3B, Bordeaux 5B, toluidine maroon, Permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermillion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS, BC), indigo, ultramarine blue, Prussian blue, anthraquinone blue, fast violet B, methyl violet lake, cobalt violet, manganese violet, dioxane violet, anthraquinone violet, chrome green, zinc green, chromium oxide, viridian, emerald green, pigment green B, naphthol green B, green gold, acid green lake, malachite green lake, phtalocyanine green, anthraquinone green, titanium oxide, zinc flower, and lithopone.

The amount of the colorant is not particularly limited and may be appropriately selected in accordance with the intended purpose. The amount is preferably 1 part by mass or more and 15 parts by mass or less, and more preferably 3 parts by mass or more and 10 parts by mass or less, relative to 100 parts by mass of the toner.

The colorant may be may be used as a masterbatch composited with a resin.

Examples of the resin used for producing the masterbatch or the resin kneaded with the masterbatch include: polymers of styrene or substituted styrene, such as polystyrene, poly-p-chlorostyrene, and polyvinyl toluene; styrene-based copolymers, such as styrene-p-chlorostyrene copolymer, styrene-propylene copolymer, styrene-vinyl toluene copolymer, copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleate copolymer; polymethyl methacrylate; polybutyl methacrylate; polyvinyl chloride; polyvinyl acetate; polyethylene; polypropylene; polyester; epoxy resins; epoxy-polyol resins; polyurethane; polyamide; polyvinyl butyral; polyacrylic acid resins; rosins; modified rosins; terpene resins; aliphatic or alicyclic hydrocarbon resins; aromatic petroleum resins; chlorinated paraffins; and paraffin waxes, in addition to the polyester resins.

These may be used alone or in combination.

The masterbatch can be obtained by mixing and kneading a resin for masterbatch and a colorant with high shear force. At this time, in order to enhance the interaction between the colorant and the resin, an organic solvent can be used. In addition, a method, in which an aqueous paste containing a colorant and water is mixed and kneaded with a resin and an organic solvent, and the colorant is transferred to a side of the resin, to remove the water content and the organic solvent content, what is known as a flushing method, is preferable because a wet cake of the colorant can be used as is without drying. For mixing and kneading, a high-shear dispersion device such as a three-roll mill is preferably used.

<Modified Layered Inorganic Mineral (Charge-Controlling Agent)>

The modified layered inorganic mineral used in the toner of the present disclosure is not particularly limited, but a material obtained by modifying a material having a basic crystal structure such as a smectite-based structure with an organic cation is desirable. When the layered inorganic mineral is, for example, hydrotalcites, a part of its bivalent metal is substituted with trivalent metal, and therefore the ion balance becomes such a balance that can introduce anions. When organic anions are introduced into the layered inorganic mineral in this state, the layered inorganic mineral can also be used as a layered inorganic compound modified with the organic anions.

When at least a part of the layered inorganic mineral is modified with organic ions, an oil phase, which has an appropriate hydrophobicity and contains a toner composition and/or a toner composition precursor, has a non-Newtonian viscosity and can deform the toner.

Examples of the layered inorganic mineral modified with organic cations include montmorillonite or bentonite, beidellite, nontronite, saponite, hectorite, attapulgite, sepiolite, and mixtures thereof. Among them, an organic modified montmorillonite or an organic modified bentonite is preferable because it does not affect toner characteristics, easily adjusts the viscosity, and can reduce the amount to be added.

Examples of an organic cation modifying agent of the modified layered inorganic mineral include quaternary alkylammonium salts, phosphonium salts, and imidazolium salts, but quaternary alkylammonium salts are desirable.

Examples of the quaternary alkylammonium include trimethylstearylammonium, c, dimethyloctadecylammonium, and oleyl bis(2-hydroxyethyl)methyl ammonium.

Examples of commercially available products of the modified layered inorganic mineral include: BENTONE 34, BENTONE 52, BENTONE 38, BENTONE 27, BENTONE 57, BENTONE SD1, BENTONE SD2, and BENTONE SD3 (manufactured by ELEMENTIS); CRAYTONE 34, CRAYTONE 40, CRAYTONE HT, CRAYTONE 2000, CRAYTONE AF, CRAYTONE APA, and CRAYTONE HY (manufactured by SCP); S-BEN, S-BEN E, S-BEN C, S-BEN NZ, S-BEN NZ70, S-BEN W, S-BEN N400, S-BEN NX, S-BEN NX80, S-BEN NO12S, S-BEN NEZ, S-BEN NO12, S-BEN WX, and S-BEN NE (manufactured by HOJUN); and KUNIBISU 110, KUNIBISU 120, and KUNIBISU 127 (manufactured by KUNIMINE INDUSTRIES CO., LTD.).

A kneaded composite of the modified layered inorganic mineral and a binder resin, what is known as a masterbatch, can be obtained by mixing and kneading a binder resin and a modified layered inorganic mineral with high shear force. At this time, in order to enhance the interaction between the modified layered inorganic mineral and the binder resin, an organic solvent can be used.

In addition, a method, in which an aqueous paste containing the modified layered inorganic mineral and water is mixed and kneaded with a resin and an organic solvent, and the modified layered inorganic mineral is transferred to a side of the resin, to remove the water content and the organic solvent content, what is known as a flushing method, is preferably used because a wet cake can be used as is without drying. For mixing and kneading, a high-shear dispersion device such as a three-roll mill is preferably used.

In the kneaded composite of the modified layered inorganic mineral and the binder resin, what is known as the masterbatch, an average dispersed particle diameter of the modified layered inorganic mineral is preferably from 0.1 μm through 0.55 μm, and the frequency of the modified layered inorganic mineral having a volume average particle diameter of 1 μm or more preferably satisfies 15% or less.

When an average dispersed particle diameter of the modified layered inorganic mineral is 0.55 μm or less and the frequency of the modified layered inorganic mineral having a volume average particle diameter of 1 μm or more is 15% or less, it is possible to overcome problems in which effects on toner shapes and toner charging properties are decreased, which is suitable.

The toner preferably includes 0.1% by mass or more and 1.4% by mass or less of the modified layered inorganic mineral, and more preferably includes 0.5% by mass or more and 1.0% by mass or less of the modified layered inorganic mineral.

When the amount of the modified layered inorganic mineral is 0.1% by mass or more, it is possible to overcome problems in which effects on toner shapes and toner charging properties are decreased, which is suitable. When the amount of the modified layered inorganic mineral is 1.4% by mass or less, it is possible to overcome the problem such as deterioration in fixability, which is suitable.

<External Additive>

The external additive is not particularly limited and may be appropriately selected in accordance with the intended purpose as long as it includes silica. Examples thereof include various inorganic fine particles and hydrophobically treated inorganic fine particles. Moreover, for example, fatty acid metal salt (e.g., zinc stearate, aluminum stearate, or the like) or fluoropolymer can also be used.

Examples of the inorganic fine particles include silica, alumina, titanium oxide, barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, oxide, zirconium oxide, barium sulfate, barium carbonate, calcium carbonate, silicon carbide, and silicon nitride. Among them, silica and titanium dioxide are particularly preferable.

Suitable examples of the additive include hydrophobically treated silica, titania, titanium oxide, and alumina fine particles. Examples of commercially available products of the silica fine particles include R972, R974, RX200, RY200, R202, R805, and R812 (all of which are manufactured by NIPPON AEROSIL CO., LTD.). Examples of commercially available products of the titania fine particles include P-25 (manufactured by NIPPON AEROSIL CO., LTD.), STT-30 and STT-65C-S (both of which are manufactured by Titan Kogyo, Ltd.), TAF-140 (manufactured by Fuji Titanium Industry Co., Ltd.), and MT-150W, MT-500B, MT-600B, and MT-150A (all of which are manufactured by TAYCA CORPORATION).

Examples of commercially available products of the hydrophobically treated titanium oxide fine particles include T-805 (manufactured by Nippon Aerosil Co. Ltd.); STT-30A and STT-65S-S (both of which are manufactured by Titan Kogyo, Ltd.); TAF-500T and TAF-1500T (both of which are manufactured by Fuji Titanium Industry Co., Ltd.); MT-100S and MT-100T (both of which are manufactured by TAYCA CORPORATION); and IT-S (manufactured by ISHIHARA SANGYO KAISHA, LTD.).

Hydrophobically treated oxide fine particles, hydrophobically treated silica fine particles, hydrophobically treated titania fine particles, and hydrophobically treated alumina fine particles can be obtained by treating, for example, hydrophilic fine particles with a silane coupling agent such as methyltrimethoxysilane, methyltriethoxysilane, or octyltrimethoxysilane. In addition, silicone oil-treated oxide fine particles and silicone oil-treated inorganic fine particles that are treated with silicone oil to which heat is applied if necessary are also suitable.

Examples of the silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacryl-modified silicone oil, and α-methylstyrene-modified silicone oil.

The average particle diameter of the primary particles of the inorganic fine particles is not particularly limited and may be appropriately selected in accordance with the intended purpose. The average particle diameter of the primary particles of the inorganic fine particles is preferably 100 nm or less, and more preferably 3 nm or more and 70 nm or less.

When the average particle diameter of the primary particles of the inorganic fine particles is 3 nm or more, it is possible to overcome problems in which the inorganic fine particles are embedded in the toner and its functions are not effectively achieved, which is suitable. When the average particle diameter of the primary particles of the inorganic fine particles is 100 nm or less, it is possible to overcome a problem in which the surface of a photoconductor is ununiformly damaged, which is suitable.

The average particle diameter of the primary particles of the hydrophobically treated inorganic fine particles is preferably 1 nm or more and 100 nm or less, and more preferably 5 nm or more and 70 nm or less. In addition, at least one kind of inorganic fine particles having the average particle diameter of primary particles of 20 nm or less and at least one kind of inorganic fine particles having the average particle diameter of primary particles of 30 nm or more are preferably included. The specific surface area measured through the BET method is preferably 20 m²/g or more and 500 m²/g or less.

The amount of the external additive is not particularly limited and may be appropriately selected in accordance with the intended purpose. The amount thereof is preferably 0.1 parts by mass or more and 5 parts by mass or less, and more preferably 0.3 parts by mass or more and 3 parts by mass or less, relative to 100 parts by mass of the toner.

<Other Components>

In addition to the aforementioned components, other components such as a flowability-improving agent, a cleanability-improving agent, and a magnetic material can be added to the toner of the present disclosure if necessary.

—Flowability-Improving Agent—

The flowability-improving agent is not particularly limited and may be appropriately selected in accordance with the intended purpose, as long as it treats the surface to increase the hydrophobicity, and can minimize deterioration in flow characteristics and charging characteristics even under high humidity. Examples thereof include silane coupling agents, silylating agents, silane coupling agents having a fluorinated alkyl group, organic titanate-based coupling agents, aluminum-based coupling agents, silicone oils, and modified silicone oils. Particularly preferably, the silica or the titanium oxide is surface-treated with such a flowability-improving agent, and is used as hydrophobic silica or hydrophobic titanium oxide.

—Cleanability-Improving Agent—

The cleanability-improving agent is added to a toner in order to remove a developer that remains on a photoconductor or a primary transfer medium after transferring. The cleanability-improving agent is not particularly limited and may be appropriately selected in accordance with the intended purpose. Examples thereof include: fatty acid metal salts such as zinc stearate, calcium stearate, and stearic acid; and polymer fine particles produced through soap-free emulsion polymerization, such as polymethyl methacrylate fine particles and polystyrene fine particles. The polymer fine particles preferably have a comparatively narrow particle size distribution, and suitably have a volume average particle diameter of 0.01 μm or more and 1 μm or less.

—Magnetic Material—

The magnetic material is not particularly limited and may be appropriately selected in accordance to the intended purpose. Examples thereof include iron powder, magnetite, and ferrite. Among them, white materials are preferable in terms of color tones.

<Glass Transition Temperature (Tg1st)>

The glass transition temperature (Tg1st) of the toner of the present disclosure at a first temperature rise in differential scanning calorimetry (DSC) is 45° C. or more and 65° C. or less, and preferably 50° C. or more and 60° C. or less.

When the (Tg1st) is 45° C. or more, it is possible to overcome problems in which the toner aggregates due to a change in temperatures during transportation of the toner or under storage environments for the case of summer season or tropical areas, to thereby cause solidification of the toner in a toner bottle and adhesion of the toner in a developing device, the toner is insufficiently supplied due to the toner clogging in the tonner bottle, and abnormal images are formed due to the adhesion of the toner in the developing device, which is suitable. The (Tg1st) of 65° C. or less is suitable because good low-temperature fixability can be obtained.

The glass transition temperatures (Tga1st and Tgb1st) of the component insoluble in THF in the toner of the present disclosure at a first temperature rise in DSC can be appropriately adjusted to desirable ranges by changing, for example, the composition ratio of the aliphatic diol and the dicarboxylic acid component of the polyester resin A, the glass transition temperature of the polyester resin B, the glass transition temperature of the polyester resin C, and the composition ratio of the polyester resin A to the polyester resin B to the polyester resin C.

### <Volume Average Particle Diameter>

The volume average particle diameter of the toner of the present disclosure is not particularly limited and may be appropriately selected in accordance to the intended purpose, but is preferably 3 μm or more and 7 μm or less. The ratio of the volume average particle diameter to the number average particle diameter is preferably 1.2 or less. In addition, a component having a volume average particle diameter of 2 μm or less is preferably included in an amount of 1% by number or more and 10% by number or less.

### <Liberation Ratio of Silica>

The liberation ratio of silica from the toner of the present disclosure is preferably 0.5% or more and 1.0% or less, and more preferably 0.6% or more and 1.0% or less. When the liberation ratio of silica is 0.5% or more, it is possible to overcome problems in which silica is easily embedded in the toner to easily deteriorate the belt cleanability, which is suitable. When the liberation ratio of silica is 1.0% or less, it is possible to overcome problems in which silica is easily separated from the toner, and the silica smears the belt or the photoconductor, which is suitable.

<Measurement of Liberation Ratio of Silica Through Ultrasonic Vibration Method>

Polyoxyalkylene alkyl ether (product name: NOIGEN ET-165, manufactured by DKS Co. Ltd.) (10 g) and pure water (300 mL) were charged into a 500 mL-beaker, and were dispersed by application of ultrasonic wave for an hour, to obtain dispersion liquid A. Then, the dispersion liquid A was transferred to a 2 L-volumetric flask. Then, pure water was added to the flask so that the total volume was 2 L to dilute the dispersion liquid A. The dispersion liquid A was dissolved by application of ultrasonic wave for an hour, to obtain a dispersion liquid B containing 0.5% polyoxyalkylene alkyl ether.

The dispersion liquid B (50 mL) was charged into a 110 mL-screw cap tube, and the toner (3.75 g) as a sample was added thereto. The materials were stirred for 30 minutes to 90 minutes until the screw cap tube was adapted to the dispersion liquid B, to obtain dispersion liquid C. At this time, the rotation was performed as slow as possible so as not to form bubbles. After the toner was sufficiently dispersed, a vibration part of an ultrasonic homogenizer (product name: VCX750, manufactured by SONICS & Materials, Inc., 20 kHz, 750 watts) was allowed to enter the dispersion liquid C to the depth of 2.5 cm, and ultrasonic vibration was applied thereto at 40% power energy for a minute, to prepare a dispersion liquid D.

The dispersion liquid D (50 mL) was charged into a centrifuge tube, and was subjected to centrifugal separation for two minutes at 2,000 rpm, to obtain a supernatant and precipitates. The precipitates were poured into a separatory funnel while washed with pure water (60 mL), and the washing water was removed through filtration under reduced pressure. The precipitates obtained after the filtration were charged into a mini cup again, pure water (60 mL) was poured into the mini cup, and the mixture was stirred five times with a handle of a spatula. At this time, the mixture was not vigorously stirred. The washing water was removed again by filtration under reduced pressure, and the toner remaining on the filter paper was collected and dried in a thermostatic chamber at 40° C. for 8 hours. The toner (3 g) obtained after the drying was pelletized so as to form pellets having a diameter of 3 mm and a thickness of 2 mm using an automatic pressure molding machine (T-BRB-32, manufactured by Maekawa; load of 6.0 t, pressing time of 60 seconds), to obtain a sample toner obtained after the treatment.

An initial sample toner that had not undergone the aforementioned treatment was similarly pelletized so as to form pellets having a diameter of 3 mm and a thickness of 2 mm, to obtain a sample toner before the treatment.

The amount of silica of the pelletized sample toner was measured in part(s) through quantitative analysis using a fluorescent X-ray device (product name: ZSX-100e, manufactured by Rigaku Corporation). Calibration curves used were prepared in advance using the sample toners containing 0.1 parts, 1 part, and 1.8 parts of silica relative to 100 parts of the toner.

The liberation ratio A of silica (% by mass) was calculated by the following formula.

Liberation ratio A of silica (% by mass)={amount of silica (parts) of sample toner obtained before treatment−amount of silica (parts) of sample toner obtained after treatment}/amount of sample toner obtained before treatment (parts)×100

### <Calculation Methods and Analysis Methods of the Respective Characteristics of Toner and Toner Constituent Components>

The calculation methods and analysis methods of the respective characteristics of the toner and the toner constituent components will be described.

The glass transition temperature Tg, the acid value, the hydroxyl value, the molecular weight, and the melting point of the toner constituent components such as the polyester resins A, B, and C, the crystalline polyester resin, and the release agent may be measured individually, but may be measured in the following manner. Specifically, the respective components are separated from the actual toner through, for example, Soxhlet extraction or gel permeation chromatography (GPC), and the separated respective components are measured. In the present disclosure, means for separating the toner constituent components in the toner can be optionally selected. The glass transition temperature Tg of the target sample is measured in the method described below.

Methods for measuring the respective glass transition temperatures of the polyester resin A, the polyester resin B, and the polyester resin C in the toner will be described by way of Examples.

The toner (1 g) is added to THF (100 mL) and is subjected to Soxhlet extraction, to obtain a THF-soluble component and a THF-insoluble component. This is dried for 24 hours in a vacuum dryer, a mixture of the polyester resin C and the crystalline polyester resin is obtained from the THF-soluble component, and a mixture of the polyester resin A and the polyester resin B is obtained from the THF-insoluble component. These are regarded as target samples, and the glass transition temperatures will be measured in the methods described below.

The polyester resin A and the polyester resin B are different in glass transition temperature. Therefore, when a mixture of the polyester resin A and the polyester resin B is obtained in the above manner and is measured for the glass transition temperatures, the glass transition temperatures of the polyester resin A and the polyester resin B can be determined.

Next, other examples will be described.

The toner (1 g) is added to THF (100 mL) while stirred for 30 minutes under the condition of 25° C., to obtain a solution in which a soluble content is dissolved. The solution is filtrated through a membrane filter having a pore of 0.2 μm, to obtain the THF-soluble component in the toner. Then, the THF-soluble component is dissolved in THF, to prepare a sample for GPC measurement. The sample is injected to GPC used for measuring the molecular weight of the polyester resin C. In addition, as samples for measuring the polyester resin A and the polyester resin B, a THF-insoluble component in the toner is considered as a sample for GPC measurement.

On the other hand, a fraction collector is disposed at an eluate outlet of the GPC, and an eluate is fractionated every predetermined count. The eluate is obtained every 5% in terms of an area ratio from the start of elution of the elution curve (rising of the curve). Next, a sample (30 mg) of each elution component is dissolved in heavy chloroform (1 mL), and 0.05% by volume of tetramethylsilane (TMS) as a reference substance is added thereto. The solution is loaded into a glass tube for NMR measurement having a diameter of 5 mm, and is subjected to accumulation 128 times at from 23° C. through 25° C. using a nuclear magnetic resonance apparatus (product name: JNM-AL400, manufactured by JEOL Ltd.), to obtain a spectrum. The monomer composition and the composition ratio of the polyester resins A, B, C, and the crystalline polyester resin contained in the toner can be determined from the peak integral ratio of the obtained spectrum.

Next, examples of the separation of each component through GPC will be described.

In the GPC measurement using THF as a mobile phase, an eluate is fractionated by, for example, a fraction collector, and fractions that correspond to a part having a desired molecular weight in the total area integration of the elution curve are collected. Then, after the collected elution is concentrated and dried using, for example, an evaporator, the solid content is dissolved in a heavy solvent such as heavy chloroform or heavy THF, and is measured through ¹H-NMR, to calculate a constituent monomer ratio of resins in the elution component from the integral ratio of each element. In addition, as another method, after an elution is concentrated, the elution is hydrolyzed with sodium hydroxide, and a decomposed product is subjected to qualitative quantitative analysis through, for example, high performance liquid chromatography (HPLC). Then, the constituent monomer ratio may be calculated.

When toner base particles are formed while a polyester resin is generated through elongation reaction and/or cross-linking reaction of a non-linear reactive precursor and a curing agent in a method of producing the toner, separation from the actual toner may be performed through, for example, GPC, to determine the Tg of the polyester resin, or a polyester resin may be separately synthesized through elongation reaction and/or cross-linking reaction of a non-linear reactive precursor and a curing agent, to determine the Tg of the synthesized polyester resin.

<<Measurement Methods of Melting Point and Glass Transition Temperature Tg>>

The melting point and the glass transition temperature Tg in the present disclosure are measured using a DSC system (differential scanning calorimeter) (“Q-200”, manufactured by TA Instruments).

Specifically, the melting point and the glass transition temperature of the target sample are measured in the following manners.

First, the target sample (about 5.0 mg) is charged in a sample container made of aluminum, and the sample container is placed on a holder unit and is set in an electric oven. Next, in a nitrogen atmosphere, the sample is heated from −80° C. to 150° C. at a temperature increase rate of 10° C./min (first temperature rise). Then, the sample is cooled from 150° C. to −80° C. at a temperature decrease rate of 10° C./min, and then further heated to 150° C. at a temperature increase rate of 10° C./min (second temperature rise). At each of the first temperature rise and the second temperature rise, a differential scanning calorimeter (“Q-200”, manufactured by TA Instruments) is used to calculate a DSC curve.

From the obtained DSC curves, a DSC curve at the first temperature rise can be selected using the analysis program in the Q-200 system, to determine a glass transition temperature of the target sample at the first temperature rise. Similarly, a DSC curve at the second temperature rise can be selected, to determine a glass transition temperature of the target sample at the second temperature rise.

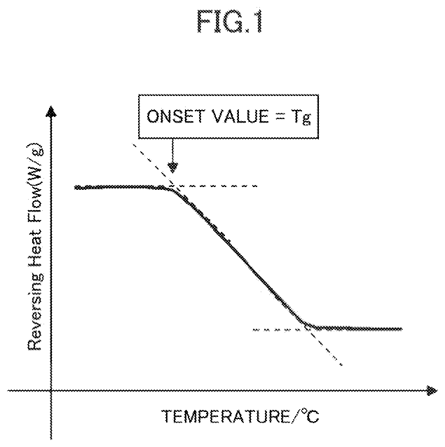

In the present disclosure, the obtained DSC curve is analyzed using the analysis program in the Q-200 system, to obtain the DSC curve as presented in FIG. 1, where the vertical axis represents “Reversing Heat Flow”. The onset value presented in FIG. 1 is regarded as Tg in the present disclosure.

This measurement is preferably the following measurement in which the modulation temperature amplitude described below is applied to increase the temperature because the glass transition temperature at the first temperature rise can be separated into two sections: Tga1st and Tgb1st in the component insoluble in THF of the toner.

(Measurement Conditions)

A modulation mode is used to heat a sample from −80° C. to 150° C. at a temperature increase rate of 1.0° C./min (first temperature rise) while the modulation temperature amplitude: ±1.0° C./min is applied thereto. Then, the sample is cooled from 150° C. to −80° C. at a temperature decrease rate of 10° C./min, and is further heated to 150° C. at a temperature increase rate of 1.0° C./min (second temperature rise).

In the same manner as described above, the obtained DSC curve is analyzed using the analysis program in the Q-200 system, to obtain the DSC curve, where the vertical axis represents “Reversing Heat Flow”. The onset value is regarded as Tg.

Moreover, from the obtained DSC curves, a DSC curve at the first temperature rise can be selected using the analysis program in the Q-200 system, to determine, as a melting point, an endothermic peak top temperature of the target sample at the first temperature rise. Similarly, a DSC curve at the second temperature rise can be selected, to determine, as a melting point, an endothermic peak top temperature of the target sample at the second temperature rise.

As described above, regarding the melting points and the glass transition temperatures Tg of the other constituent components such as the polyester resins A, B, and C and the release agent, unless otherwise specified, an endothermic peak top temperature and a glass transition temperature Tg2nd at the second temperature rise are regarded as a melting point and a glass transition temperature Tg of each target sample.

<Mass Ratio of Each Polyester Resin Component>

In the present disclosure, it is preferable to satisfy the following relation (2), where the mass ratio of the polyester resin A is a, the mass ratio of the polyester resin B is b, and the mass ratio of the polyester resin C is c, relative to the total mass of the polyester resin A, the polyester resin B, and the polyester resin C.

4(a+b)<c relation (2)

When the relation (2) is satisfied, separation of a resin can be minimized, and poor dispersion of a pigment or a decrease in a degree of coloring can be minimized. In addition, good images can be obtained, and the fixing region⋅storage ability can be ensured.

In the present embodiment, the mass ratio of the polyester resins can be determined as described above. Specifically, a mixture of the polyester resins A and B and a mixture of the polyester resin C and the crystalline polyester resin in the toner are obtained through, for example, Soxhlet extraction or GPC, and their masses can be used to determine the mass ratio.

<Method of Producing Toner>

A method of producing the toner is not particularly limited and may be appropriately selected in accordance with the intended purpose. It is preferable to disperse, in an aqueous medium, an oil phase, which contains the polyester resins A, B, and C, and contains, if necessary, the crystalline polyester resin, the release agent, or the colorant, to granulate the toner.

In addition, it is more preferable to disperse, in an aqueous medium, an oil phase, to granulate the toner. Here, the oil phase contains, as the polyester resins A and B, polyester resins that are prepolymers and have either or both of a urethane bond and a urea bond and a polyester resin that does not have either or both of a urethane bond and a urea bond, preferably contains the crystalline polyester resin, and further contains, for example, the curing agent, the release agent, or the colorant if necessary.

Examples of such a method of producing the toner include conventional dissolution suspension methods.

As one example, a method in which toner base particles are formed while a polyester resin is generated through elongation reaction and/or cross-linking reaction of the prepolymer and the curing agent will be described.

In this method, preparation of an aqueous medium, preparation of an oil phase containing toner materials, emulsification or dispersion of the toner materials, and removal of an organic solvent are performed.

—Preparation of Aqueous Medium (Aqueous Phase)—

The preparation of an aqueous medium can be performed by dispersing, for example, resin particles in an aqueous medium. The amount of the resin particles added to the aqueous medium is not particularly limited and may be appropriately selected in accordance with the intended purpose. The amount thereof is preferably 0.5 parts by mass or more and 10 parts by mass or less relative to 100 parts by mass of the aqueous medium.

The aqueous medium is not particularly limited and may be appropriately selected in accordance with the intended purpose. Examples thereof include water, solvents miscible with water, and mixtures thereof. These may be used alone or in combination. Among them, water is preferable.

The solvent miscible with water is not particularly limited and may be appropriately selected in accordance with the intended purpose. Examples thereof include alcohols, dimethylformamide, tetrahydrofuran, cellosolves, and lower ketones. Examples of the alcohols include methanol, isopropanol, and ethylene glycol. Examples of the lower ketones include acetone and methyl ethyl ketone.

—Preparation of Oil Phase—

The preparation of an oil phase containing toner materials in the present embodiment can be performed by dissolving or dispersing, in an organic solvent, toner materials, which contain the polyester resins A and B that are prepolymers and have either or both of a urethane bond and a urea bond and a polyester resin C that does not have either or both of a urethane bond and a urea bond, and contain, if necessary, the crystalline polyester resin, the curing agent, the release agent, or the colorant.

The organic solvent is not particularly limited and may be appropriately selected in accordance with the intended purpose. However, an organic solvent having a boiling point of less than 150° C. is preferable because such an organic solvent is easily removed.

Examples of the solvent having a boiling point of less than 150° C. include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone.

These may be used alone or in combination.

Among them, ethyl acetate, toluene, xylene, benzene, methylene chloride, 1,2-dichloroethane, chloroform, and carbon tetrachloride are preferable, and ethyl acetate is more preferable.

—Emulsification or Dispersion—

The emulsification or dispersion of the toner materials can be performed by dispersing, in the aqueous medium, an oil phase containing the toner materials. When the toner materials are emulsified or dispersed, the curing agent can be reacted with the prepolymer through elongation reaction and/or cross-linking reaction.

The reaction conditions (reaction time and reaction temperature) under which the prepolymer is generated are not particularly limited and may be appropriately selected in accordance with combinations of the curing agent and the prepolymer. The reaction time is preferably from 10 minutes through 40 hours, and more preferably from 2 hours through 24 hours.

The reaction temperature is preferably from 0° C. through 150° C., and more preferably from 40° C. through 98° C.

A step of uniformly dispersing the oil phase is not particularly limited and a homomixer, a milder, or a bead mill may be appropriately selected in accordance with conditions such as the formulation of the oil phase or the viscosity of the oil phase. The dispersion time is preferably from 1 hour through hours, and more preferably from 1 hour through 3 hours.

A method of stably forming a dispersion liquid containing the prepolymer in the aqueous medium is not particularly limited and may be appropriately selected in accordance with the intended purpose. Examples thereof include a method in which an oil phase prepared by dissolving or dispersing toner materials in a solvent is added to an aqueous medium phase, followed by dispersion with shear force.

A disperser for the dispersion is not particularly limited and may be appropriately selected in accordance with the intended purpose. Examples thereof include low-speed shearing type dispersers, high-speed shearing type dispersers, friction type dispersers, high-pressure jet type dispersers, and ultrasonic dispersers. Among them, a high-speed shearing type disperser is preferable because a particle diameter of the dispersion element (oil droplets) can be adjusted to from 2 μm through 20 μm.

When the high-speed shearing type disperser is used, conditions such as the number of revolutions, the dispersion time, and the dispersion temperature may be appropriately selected in accordance with the intended purpose. The number of revolutions is preferably from 1,000 rpm through 30,000 rpm, and more preferably from 5,000 rpm through 20,000 rpm. The dispersion time is preferably from 0.1 minutes through 5 minutes in a batch system. The dispersion temperature is preferably from 0° C. through 150° C., and more preferably from 40° C. through 98° C. under pressure. Note that, generally, the higher the dispersion temperature, the easier the dispersion.

The amount of the aqueous medium used when the toner materials are emulsified and dispersed is not particularly limited and may be appropriately selected in accordance with the intended purpose. The amount thereof is preferably from 50 parts by mass through 2,000 parts by mass, and more preferably 100 parts by mass or more and 1,000 parts by mass or less, relative to 100 parts by mass of the toner materials.

When the amount of the aqueous medium used is 50 parts by mass or more relative to 100 parts by mass of the toner materials, it is possible to overcome problems in which the toner materials are poorly dispersed, failing to obtain toner base particles having a predetermined particle diameter, which is suitable. When the amount of the aqueous medium used is 2000 parts by mass or less relative to 100 parts by mass of the toner materials, it is possible to overcome a problem such as increased production costs, which is suitable.

When an oil phase containing the toner materials is emulsified or dispersed, a dispersant is preferably used because a dispersion element such as oil droplets is stabilized, a desired shape is achieved, and a particle size distribution becomes sharp.

The dispersant is not particularly limited and may be appropriately selected in accordance with the intended purpose. Examples thereof include surfactants, poorly water-soluble inorganic compound dispersants, and polymeric protective colloids. These may be used alone or in combination. Among them, surfactants are preferable.

The surfactant is not particularly limited and may be appropriately selected in accordance with the intended purpose. For example, an anionic surfactant, a cationic surfactant, a nonionic surfactant, and an amphoteric surfactant can be used. Examples of the anionic surfactant include alkylbenzene sulfonate, α-olefin sulfonate, and phosphate. Among them, those having a fluoroalkyl group are preferable.

### —Removal of an Organic Solvent—

A method of removing the organic solvent from the dispersion liquid such as the emulsified slurry is not particularly limited and may be appropriately selected in accordance with the intended purpose. Examples thereof include: a method in which the temperature of the entire reaction system is gradually increased to evaporate an organic solvent from oil droplets; and a method in which a dispersion liquid is sprayed in a dry environment to remove an organic solvent from oil droplets.

When the organic solvent is removed, toner base particles are formed. For example, the toner base particles can be washed and dried, and can be further classified. The classification can be performed by removing fine particle parts in the liquid with a cyclone, with a decanter, or through centrifugal separation, or may be performed after drying.

The obtained toner base particles may be mixed with particles such as the external additive and the charge-controlling agent. At this time, application of mechanical impact can minimize detaching of the particles such as the external additive from surfaces of the toner base particles.

A method of applying the mechanical impact is not particularly limited and may be appropriately selected in accordance with the intended purpose. Examples thereof include: a method in which impact force is applied to the mixture using a blade rotating at a high speed; and a method in which the mixture is charged into a high-speed air flow and is accelerated to allow the particles collide with each other or allow the particles collide with an appropriate collision plate.

A device used in the above method is not particularly limited and may be appropriately selected in accordance with the intended purpose. Examples thereof include an Angmill (manufactured by HOSOKAWA MICRON CORPORATION), a device obtained by modifying an I-type mill (manufactured by Nippon Pneumatic Mfg. Co., Ltd.) to decrease a pulverization air pressure, a hybridization system (manufactured by NARA MACHINERY CO., LTD.), Kryptron System (manufactured by Kawasaki Heavy Industries, Ltd.), and an automatic mortar.

In the present disclosure, it is preferable to further add a homogenization step. When the homogenization step is added, raw materials constituting the oil phase can be arranged in oil droplets in a fine and uniform manner, and, particularly, the raw materials can be efficiently arranged on the surface of the toner even with a small amount of the modified layered inorganic mineral. The present inventors found that this makes it possible to satisfy low-temperature fixability and heat-resistant storage stability without deteriorating the characteristics of the polyester resins A, B, and C.

(Developer)

The developer of the present disclosure includes at least the toner of the present disclosure, and further includes appropriately selected other components, such as a carrier, if necessary. Therefore, the developer can achieve excellent charging ability and excellent n transferability, and can stably form images with high quality. The developer may be a one-component developer or a two-component developer. When the developer is used in a high-speed printer that can handle improved information processing speeds made possible recent years, a two-component developer is preferably used because the service life can be improved.

When the developer is used as a one-component developer, there is a slight change in the particle diameter of the toner even after the toner is consumed and refilled, there are less filming of the toner to a developing roller and less fusion of the toner to a member such as a blade configured to make a layer of the toner thin, and excellent and stable developing properties and images are obtained even after the developer is stirred in a developing device for a long period of time.

When the developer is used as a two-component developer, there is a slight change in the particle diameter of the toner after the toner is consumed and refilled for a long period of time, and excellent and stable developing properties and images are obtained even after the developer is stirred in a developing device for a long period of time.

<Carrier>

The carrier is not particularly limited and may be appropriately selected in accordance with the intended purpose. The carrier preferably includes a core and a resin layer covering the core.

—Core—

A material of the core is not particularly limited and may be appropriately selected in accordance with the intended purpose. Examples thereof include manganese-strontium-based materials of from 50 emu/g through 90 emu/g, and manganese-magnesium-based materials of from 50 emu/g through 90 emu/g.

In order to ensure image density, high magnetic materials, such as iron powder of 100 emu/g or greater and magnetite of from 75 emu/g through 120 emu/g is preferably used. Moreover, low magnetic materials, such as copper/zinc-based materials of from 30 emu/g through 80 emu/g are preferably used because impact of the developer in the form of a brush to the photoconductor can be weakened, and an image with high quality can be advantageously formed.

These may be used alone or in combination.

A volume average particle diameter of the core is not particularly limited and may be appropriately selected in accordance with the intended purpose. The volume average particle diameter is preferably from 10 μm through 150 μm, and more preferably from 40 μm through 100 μm.

When the volume average particle diameter of the core is 10 μm or more, it is possible to overcome problems in which a lot of fine powder forms in a carrier, and magnetization per particle decreases consequently scattering the carrier, which is suitable. When the volume average particle diameter of the core is 150 μm or less, it is possible to overcome problems in which the specific surface area may decrease consequently scattering the toner, and, particularly, reproduction of solid portions may be worsen in a full color image having a lot of solid portions, which is suitable.

The toner of the present disclosure may be mixed with the carrier, to be used in a two-component developer.

The amount of the carrier in the two-component developer is not particularly limited and may be appropriately selected in accordance with the intended purpose. The amount of the carrier is preferably 90 parts by mass or more and 98 parts by mass or less, and more preferably 93 parts by mass or more and 97 parts by mass or less, relative to 100 parts by mass of the two-component developer.

The developer of the present disclosure can suitably used for image formation according to various conventional electrophotographic methods, such as a magnetic one-component developing method, a non-magnetic one-component developing method, and a two-component developing method.

(Toner-Storing Unit)

The toner-storing unit in the present disclosure includes: a unit having a function of storing a toner; and a toner stored in the unit. Here, examples of the toner-storing unit include a toner-storing container, a developing device, and a process cartridge.

The toner-storing container refers to a container that stores a toner.

The developing device is a device having a unit that stores a toner and is configured to develop the toner.

The process cartridge refers to a cartridge, which includes at least an electrostatic latent image bearer (also referred to as an image bearer) and a developing unit that are integrated, stores a toner, and is detachably mountable to an image forming apparatus. The process cartridge may further include at least one selected from a charging unit, an exposure unit, and a cleaning unit.

When the toner-storing unit of the present disclosure is attached to an image forming apparatus to form an image, it is possible to form a high-definition and high-quality image while the brightness of the image is ensured.

(Developer-Storing Container)

A developer-storing container that stores the developer of the present disclosure is not particularly limited and may be appropriately selected from conventional developer-storing containers. Examples of the container include a container that includes a container main body and a cap.

The size, shape, structure, and material of the developer-storing container main body are also not particularly limited. Preferably, the developer-storing container main body has, for example, a cylindrical shape. Particularly preferably, the developer-storing container main body includes spiral unevenness on the inner peripheral surface and can be rotated to transfer the contents, the developer to the discharge port side, and part or all of the spiral unevenness includes functions as a bellows.

The material of the developer-storing container having a good dimensional accuracy is preferable. Examples thereof include resin materials such as polyester resins, polyethylene resins, polypropylene resins, polystyrene resins, polyvinyl chloride resins, polyacrylic acid, polycarbonate resin components, ABS resins, and polyacetal resins.

The developer-storing container is easily stored or transported and achieves an excellent handling property. Therefore, the developer-storing container is detachably mounted on, for example, a process cartridge and an image forming apparatus that will be described below, and can be used for supplementing the developer.

(Image Forming Apparatus and Image Forming Method)

The image forming apparatus of the present disclosure includes at least an electrostatic latent image bearer, an electrostatic latent image forming unit, and a developing unit. The image forming apparatus further includes other units according to the necessity.

The image forming method of the present disclosure includes at least an electrostatic latent image forming step and a developing step, and further includes other steps if necessary.

<Electrostatic Latent Image Bearer>

The material, structure, and size of the electrostatic latent image bearer are not particularly limited and may be appropriately selected from conventional materials, structures, and sizes thereof. Examples of the materials include inorganic photoconductors (e.g., amorphous silicon and selenium) and organic photoconductors (e.g., polysilane and phthalopolymethine). Among them, amorphous silicon is preferable in terms of long service life.

The linear velocity of the electrostatic latent image bearer is preferably 300 mm/s or more.

<Electrostatic Latent Image Forming Unit and Electrostatic Latent Image Forming Step>

The electrostatic latent image forming unit is not particularly limited and may be appropriately selected in accordance with the intended purpose, as long as the electrostatic latent image forming unit is a unit configured to form an electrostatic latent image on the electrostatic latent image bearer. Examples thereof include a unit including a charging member configured to charge a surface of the electrostatic latent image bearer, and an exposing member configured to expose the surface of the electrostatic latent image bearer to light in an imagewise manner.

The electrostatic latent image forming step is not particularly limited and may be appropriately selected in accordance with the intended purpose, as long as the electrostatic latent image forming step is a step of forming an electrostatic latent image on the electrostatic latent image bearer. For example, the electrostatic latent image forming step can be performed by charging the surface of the electrostatic latent image bearer, followed by exposing the surface of the electrostatic latent image bearer to light in an imagewise manner. The electrostatic latent image forming step can be performed by the electrostatic latent image forming unit.

<<Charging Member and Charging>>

The charging member is not particularly limited and may be appropriately selected in accordance with the intended purpose. Examples of the charging member include: conventional contact chargers, equipped with, for example, a conductive or semiconductive roller, brush, film, or rubber blade; and non-contact chargers utilizing corona discharge, such as corotron and scorotron.

For example, the charging can be performed by applying voltage to the surface of the electrostatic latent image bearer using the charging member.

As the shape of the charging member, the charging member may be in any form, such as a magnetic brush, and a fur brush, as well as a roller. The shape of the charging member may be selected in accordance with the specification or embodiment of the image forming apparatus.

The charging member is not limited to the above-mentioned contact charging members, but the contact charging member is preferably used because an image forming apparatus including such a charging member can reduce an amount of ozone generated from the charging member.

<<Exposing Member and Exposing>>

The exposing member is not particularly limited and may be appropriately selected in accordance with the intended purpose, as long as the exposing member can expose the surface of the electrostatic latent image bearer charged by the charging member to light in an imagewise manner. Examples thereof include various exposing members, such as copy optical exposing members, rod lens array exposing members, laser optical exposing members, and liquid crystal shutter optical exposing members.

A light source used for the exposing member is not particularly limited and may be appropriately selected in accordance with the intended purpose. Examples thereof include general light emitters, such as fluorescent lamps, tungsten lamps, halogen lamps, mercury lamps, sodium vapor lamps, light emitting diodes (LEDs), semiconductor lasers (LDs), and electroluminescent light (EL).

In order to emit only light having a desired wavelength range, various filters, such as sharp-cut filters, band-pass filters, near infrared ray-cut filters, dichroic filters, interference filters, and color temperature conversion filters, may be used.

For example, the exposing may be performed by exposing the surface of the electrostatic latent image bearer to light in an imagewise manner using the exposing member.

In the present disclosure, a back-exposure system may be employed. The back-exposure system is a system in which the exposing is performed in an imagewise manner from the back side of the electrostatic latent image bearer.

<Developing Unit and Developing Step>

The developing unit is not particularly limited and may be appropriately selected in accordance with the intended purpose, as long as it is a developing unit, which stores a toner and is configured to develop the electrostatic latent image formed on the electrostatic latent image bearer, to form a toner image that is a visible image.

The developing step is not particularly limited and may be appropriately selected in accordance with the intended purpose, as long as it is a step of developing, with a toner, the electrostatic latent image formed on the electrostatic latent image bearer, to form a toner image that is a visible image. For example, the developing step may be performed by the developing unit.

The developing unit preferably includes: a stirrer configured to stir the toner with friction to charge the toner; and a rotatable developer bearer that includes a magnetic field generating unit fixed inside the developer bearer, and is configured to bear a developer including the toner on the surface thereof.

<Other Units and Other Steps>

Examples of the other units include transferring units, fixing units, cleaning units, charge-eliminating units, recycling units, and controlling units.

Examples of the other steps include a transferring step, a fixing step, a cleaning step, a charge-eliminating step, a recycling step, and a controlling step.

<<Transferring Unit and Transferring Step>>

The transferring unit is not particularly limited and may be appropriately selected in accordance with the intended purpose, as long as it is a unit configured to transfer the visible image to a recording medium. An embodiment including a first transferring unit and a second transferring unit is preferable, where the first transferring unit is configured to transfer a visible image to an intermediate transfer member to form a composite transfer image, and the second transferring unit is configured to transfer the composite transfer image to a recording medium.

The transferring step is not particularly limited and may be appropriately selected in accordance with the intended purpose, as long as it is a step of transferring the visible image to a recording medium. An embodiment, in which an intermediate transfer member is used to primarily transfer a visible image on the intermediate transfer member, followed by secondarily transferring the visible images to the recording medium, is preferable.

For example, the transferring step can be a step of charging the photoconductor with a transfer charger to transfer the visible image, and can be performed by the transferring unit.

When an image secondarily transferred to the recording medium is a color image composed of multiple color toners, toners of the respective colors can be sequentially superimposed onto the intermediate transfer member by the transferring unit to form an image on the intermediate transfer member, and the composite image on the intermediate transfer member can be secondarily transferred to the recording medium by the intermediate transferring unit.

The intermediate transfer member is not particularly limited and may be appropriately selected from publicly-known transfer members according to the intended purpose. For example, a transfer belt is suitably used.

The transferring unit (e.g., the primary transferring unit, and the secondary transferring unit) preferably includes at least a transfer device configured to allow the visible image formed on the photoconductor to undergo peeling electrification to the side of the recording medium. Examples of the transfer device include corona transfer devices using corona discharge, transfer belts, transfer rollers, press transfer rollers, and adhesion transfer devices.

A typical example of the recording medium is plain paper. The recording medium is not particularly limited and may be appropriately selected in accordance with the intended purpose, as long as the recording medium is a medium to which an unfixed image after developing can be transferred. A PET-based recording medium for OHP may also be used.

<<Fixing Unit and Fixing Step>>

The fixing unit is not particularly limited and may be appropriately selected in accordance with the intended purpose, as long as the fixing unit is a unit configured to fix the transfer image transferred to the recording medium. The fixing unit is preferably a conventional heat press member. Examples of the heat press member include a combination of a heating roller and a press roller, and a combination of a heat roller, a press roller, and an endless belt.

The fixing step is not particularly limited and may be appropriately selected in accordance with the intended purpose, as long as the fixing step is a step of fixing the visible image transferred to the recording medium. For example, the fixing step may be performed every time the toner of each color is transferred to the recording medium, or the fixing step may be simultaneously performed at one time with the toners of the respective colors being superimposed.

The fixing step can be performed by the fixing unit.

Heating by the press heat member is preferably performed at from 80° C. through 200° C.

In the present disclosure, for example, a conventional optical fixing device may be used in combination with or instead of the fixing unit in accordance with the intended purpose.

The surface pressure applied during the fixing step is not particularly limited and may be appropriately selected in accordance with the intended purpose. The surface pressure is preferably from 10 N/cm² through 80 N/cm².

<<Cleaning Unit and Cleaning Step>>

The cleaning unit is not particularly limited and may be appropriately selected in accordance with the intended purpose, as long as the cleaning unit is a unit capable of removing the toner remaining on the photoconductor. Examples of the cleaning unit include magnetic brush cleaners, electrostatic brush cleaners, magnetic roller cleaners, blade cleaners, brush cleaners, and web cleaners.

The cleaning step is not particularly limited and may be appropriately selected in accordance with the intended purpose, as long as the cleaning step is a step of removing the toner remaining on the photoconductor. For example, the cleaning step can be performed by the cleaning unit.

<<Charge-Eliminating Unit and Charge-Eliminating Step>>

The charge-eliminating unit is not particularly limited and may be appropriately selected in accordance with the intended purpose, as long as the charge-eliminating unit is a unit configured to apply charge-eliminating bias to the photoconductor to eliminate the charge. Examples of the charge-eliminating unit include charge-eliminating lamps.

The charge-eliminating step is not particularly limited and may be appropriately selected in accordance with the intended purpose, as long as the charge-eliminating step is a step of applying charge-eliminating bias to the photoconductor to eliminate the charge. For example, the charge-eliminating step can be performed by the charge-eliminating unit.

<<Recycling Unit and Recycling Step>>

The recycling unit is not particularly limited and may be appropriately selected in accordance with the intended purpose, as long as the recycling unit is a unit configured to recycle the toner removed by the cleaning step to the developing device. Examples of the recycling unit include conventional conveying units.

The recycling step is not particularly limited and may be appropriately selected in accordance with the intended purpose, as long as the recycling step is a step of recycling the toner removed by the cleaning step to the developing device. For example, the recycling step can be performed by the recycling unit.

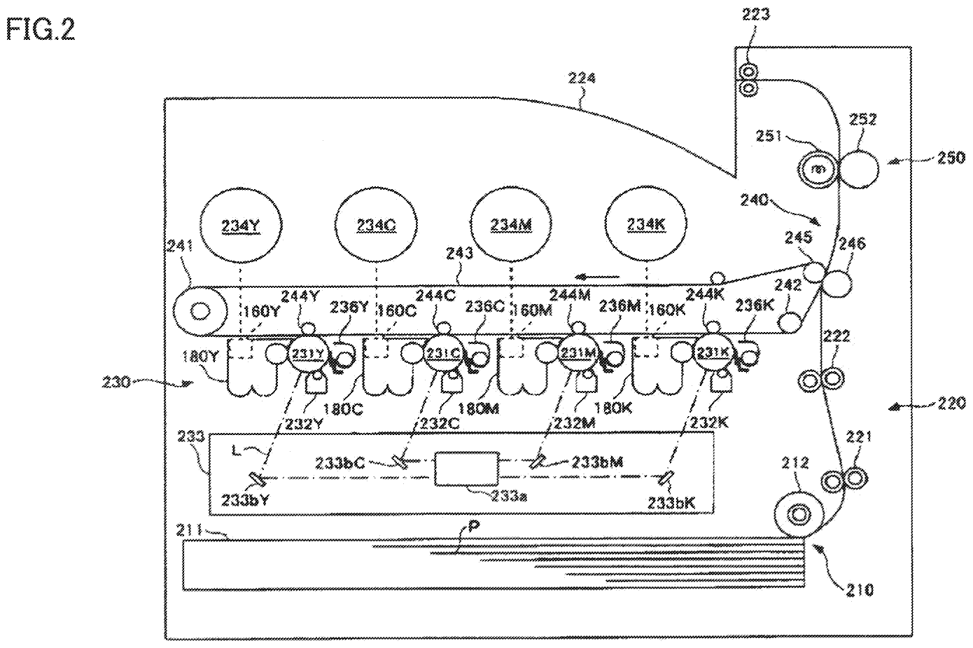

Next, one embodiment where a method of forming an image is performed using the image forming apparatus of the present disclosure will be described with reference to FIG. 2. As the image forming apparatus of the present embodiment, a printer is exemplified. The image forming apparatus is not particularly limited as long as a toner can be used to form an image. Examples thereof include copiers, facsimiles, and multifunction peripherals.

The image forming apparatus includes a sheet feeding unit 210, a conveying unit 220, an image formation unit 230, a transfer unit 240, and a fixing unit 250.

The sheet feeding unit 210 includes: a sheet feeding cassette 211 in which sheets of paper P to be fed are stacked; and a sheet feeding roller 212 configured to feed the sheets of paper P stacked in the sheet feeding cassette 211 one by one.

The conveying unit 220 includes: a roller 221 configured to convey the paper P fed by the sheet feeding roller 212 in a direction of the transfer unit 240; a pair of timing rollers 222 configured to nip the leading end of the paper P conveyed by the roller 221 to hold the leading end of the paper P and to send the paper to the transfer unit 240 at a predetermined timing; and a paper ejection roller 223 configured to eject, to a paper ejection tray 224, the paper P on which a color toner image has been fixed.

The image formation unit 230 includes an image forming unit 180Y configured to form an image using a developer including a yellow toner, an image forming unit 180C configured to form an image using a developer including a cyan toner, an image forming unit 180M configured to form an image using a developer including a magenta toner, an image forming unit 180K configured to form an image using a developer including a black toner, and an exposure device 233 at predetermined intervals in this order from left to right in the drawing.

In the drawing, each of the image forming units 180 (180Y, 180C, 180M, 180K) is rotatably provided in the clockwise direction, and includes: a photoconductor drum 231 (231Y, 231C, 231M, 231K) on which an electrostatic latent image and a toner image are formed; a charger 232 (232Y, 232C, 232M, 232K) configured to charge the surface of the photoconductor drum 231 (231Y, 231C, 231M, 231K) in an imagewise manner; and a cleaner 236 (236Y, 236C, 236M, 236K) configured to remove a toner remaining on the photoconductor drum 231 (231Y, 231C, 231M, 231K).

Moreover, each of the image forming units 180 (180Y, 180C, 180M, 180K) includes: a toner bottle 234 (234Y, 234C, 234M, 234K) configured to store a toner of each color; and a sub hopper 160 (160Y, 160C, 160M, and 160K) configured to supply the tonner supplied from the toner bottle 234 (234Y, 234C, 234M, 234K).

When any image forming unit of the image forming units 180 (180Y, 180C, 180M, 180K) is described, it is simply referred to as an image forming unit.

The exposure device 233 is configured to reflect laser light L emitted from a light source 233a based on image information by a polygon mirror 233b (233bY, 233bC, 233bM, 233bK) rotatably driven by a motor, to irradiate the photoconductor drum 231.

The developer includes a toner and a carrier. Four image forming units 180 (180Y, 180C, 180M, 180K) have substantially the same mechanical configuration except that the respective developers used are different.

The transfer unit 240 includes: a driving roller 241; a driven roller 242; an intermediate transfer belt 243 that can rotate in a counterclockwise direction in FIG. 2 as the driving roller 241 is driven; primary transfer rollers 244 (244Y, 244C, 244M, 244K) that are disposed so as to face the photoconductor drums 231 (231Y, 231C, 231M, 231K), and are configured to nip the intermediate transfer belt 243; and a secondary counter roller 245 and a secondary transfer roller 246 that are disposed so as to face each other, and are configured to nip the intermediate transfer belt 243 at a position where the toner image is transferred to paper.

The fixing unit 250 includes a heater therein. The fixing unit 250 includes: a fixing belt 251 configured to heat the paper P; and a pressure roller 252 configured to rotatably apply pressure to the fixing belt 251 to thereby form a nip. As a result, heat and pressure are applied to the color toner on the paper P, to fix the color toner image. The paper P on which the color toner image has been fixed is ejected to a paper ejection tray 224 by the paper ejection roller 223, and a series of image forming processes is completed.

(Process Cartridge)

The process cartridge according to the present disclosure can be detachably mounted on various image forming apparatuses. The process cartridge includes at least an electrostatic latent image bearer configured to bear an electrostatic latent image, and a developing unit configured to develop the electrostatic latent image born on the electrostatic latent image bearer with the developer of the present disclosure, to form a toner image. The process cartridge of the present disclosure may further include other units according if necessary.

The developing unit includes at least a developer-storing part that stores the developer of the present disclosure, and a developer bearing member configured to bear the developer stored inside the developer-storing part and to transport the developer. The developing unit may further include a regulating member configured to regulate a thickness of the born developer.

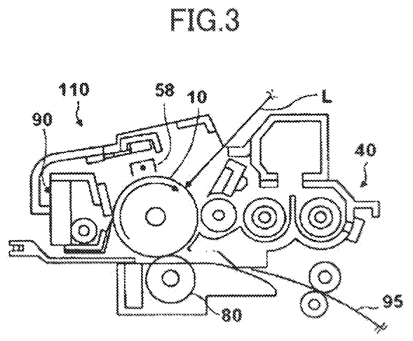

FIG. 3 illustrates an example of the process cartridge according to the present disclosure. A process cartridge 110 includes a photoconductor drum 10, a corona discharger 58, a developing device 40, a transfer roller 80, and a cleaning device 90.

### EXAMPLES

Hereinafter, the present disclosure will be described in detail with reference to Examples, but is not limited to the following Examples. Here, “part(s)” means “part(s) by mass” and “%” means “% by mass” unless otherwise specified.

### Production Example A-1

<Synthesis of Prepolymer A-1 (Polyester Resin A-1)>

A reaction container equipped with a cooling tube, a stirrer, and a nitrogen-introducing tube was charged with 3-methyl-1,5-pentanediol, isophthalic acid, adipic acid, and trimellitic anhydride together with titanium tetraisopropoxide (1,000 ppm relative to the resin components) so that a molar ratio (OH/COOH) of the hydroxyl group to the carboxyl group was 1.5, the diol component was constituted with 100 mol % of 3-methyl-1,5-pentanediol, the dicarboxylic acid component was constituted with 40 mol % of isophthalic acid and 60 mol % of adipic acid, and the amount of trimellitic anhydride in the whole monomer was 1 mol %.

The obtained mixture was heated to 200° C. for about 4 hours, and was further heated to 230° C. for 2 hours. Then, the mixture was allowed to react until water was not discharged.

Then, the mixture was further allowed to react under reduced pressure of from 10 mmHg through mmHg for 5 hours, to obtain [intermediate polyester A-1].

Next, a reaction container equipped with a cooling tube, a stirrer, and a nitrogen-introducing tube was charged with the [intermediate polyester A-1] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer A-1].

Regarding the [prepolymer A-1], [polyester resin A-1], which corresponds to a polyester resin A in the present disclosure, was generated in the production process of the toner in Examples and Comparative Examples described later.

In addition, regarding the prepolymers of Production Examples A-2 to A-5 described below and the prepolymers of Production Examples B-1 to B-3 described below, polyester resins A-1 to A-5 and polyester resins B-1 to B-3 were generated in the production process of the toner.

### Production Example A-2

<Synthesis of Prepolymer A-2 (Polyester Resin A-2)>

A reaction container equipped with a cooling tube, a stirrer, and a nitrogen-introducing tube was charged with 3-methyl-1,5-pentanediol, isophthalic acid, adipic acid, and trimellitic anhydride together with titanium tetraisopropoxide (1,000 ppm relative to the resin components) so that a molar ratio (OH/COOH) of the hydroxyl group to the carboxyl group was 1.5, the diol component was constituted with 100 mol % of 3-methyl-1,5-pentanediol, the dicarboxylic acid component was constituted with 33 mol % of isophthalic acid and 67 mol % of adipic acid, and the amount of trimellitic anhydride in the whole monomer was 1 mol %.

The obtained mixture was heated to 200° C. for about 4 hours, and was further heated to 230° C. for 2 hours. Then, the mixture was allowed to react until water was not discharged.

Then, the mixture was further allowed to react under reduced pressure of from 10 mmHg through mmHg for 5 hours, to obtain [intermediate polyester A-2].

Next, a reaction container equipped with a cooling tube, a stirrer, and a nitrogen-introducing tube was charged with the [intermediate polyester A-2] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer A-2].

### Production Example A-3

<Synthesis of Prepolymer A-3 (Polyester Resin A-3)>

A reaction container equipped with a cooling tube, a stirrer, and a nitrogen-introducing tube was charged with 3-methyl-1,5-pentanediol, isophthalic acid, adipic acid, and trimellitic anhydride together with titanium tetraisopropoxide (1,000 ppm relative to the resin components) so that a molar ratio (OH/COOH) of the hydroxyl group to the carboxyl group was 1.5, the diol component was constituted with 100 mol % of 3-methyl-1,5-pentanediol, the dicarboxylic acid component was constituted with 67 mol % of isophthalic acid and 33 mol % of adipic acid, and the amount of trimellitic anhydride in the whole monomer was 1 mol %.

The obtained mixture was heated to 200° C. for about 4 hours, and was further heated to 230° C. for 2 hours. Then, the mixture was allowed to react until water was not discharged.

Then, the mixture was further allowed to react under reduced pressure of from 10 mmHg through mmHg for 5 hours, to obtain [intermediate polyester A-3].

Next, a reaction container equipped with a cooling tube, a stirrer, and a nitrogen-introducing tube was charged with the [intermediate polyester A-3] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer A-3].

### Production Example A-4

<Synthesis of Prepolymer A-4 (Polyester Resin A-4)>

A reaction container equipped with a cooling tube, a stirrer, and a nitrogen-introducing tube was charged with 3-methyl-1,5-pentanediol, isophthalic acid, adipic acid, and trimellitic anhydride together with titanium tetraisopropoxide (1,000 ppm relative to the resin components) so that a molar ratio (OH/COOH) of the hydroxyl group to the carboxyl group was 1.5, the diol component was constituted with 100 mol % of 3-methyl-1,5-pentanediol, the dicarboxylic acid component was constituted with 30 mol % of isophthalic acid and 70 mol % of adipic acid, and the amount of trimellitic anhydride in the whole monomer was 1 mol %.

The obtained mixture was heated to 200° C. for about 4 hours, and was further heated to 230° C. for 2 hours. Then, the mixture was allowed to react until water was not discharged.

Then, the mixture was further allowed to react under reduced pressure of from 10 mmHg through mmHg for 5 hours, to obtain [intermediate polyester A-4].

Next, a reaction container equipped with a cooling tube, a stirrer, and a nitrogen-introducing tube was charged with the [intermediate polyester A-4] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer A-4].

### Production Example A-5

<Synthesis of prepolymer A-5 (polyester resin A-5)>

A reaction container equipped with a cooling tube, a stirrer, and a nitrogen-introducing tube was charged with 3-methyl-1,5-pentanediol, isophthalic acid, adipic acid, and trimellitic anhydride together with titanium tetraisopropoxide (1,000 ppm relative to the resin components) so that a molar ratio (OH/COOH) of the hydroxyl group to the carboxyl group was 1.5, the diol component was constituted with 100 mol % of 3-methyl-1,5-pentanediol, the dicarboxylic acid component was constituted with 70 mol % of isophthalic acid and 30 mol % of adipic acid, and the amount of trimellitic anhydride in the whole monomer was 1 mol %.

The obtained mixture was heated to 200° C. for about 4 hours, and was further heated to 230° C. for 2 hours. Then, the mixture was allowed to react until water was not discharged.

Then, the mixture was further allowed to react under reduced pressure of from 10 mmHg through mmHg for 5 hours, to obtain [intermediate polyester A-5].

Next, a reaction container equipped with a cooling tube, a stirrer, and a nitrogen-introducing tube was charged with the [intermediate polyester A-5] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer A-5].

### Production Example B-1

<Synthesis of Prepolymer B-1 (Polyester Resin B-1)>

A reaction container equipped with a cooling tube, a stirrer, and a nitrogen-introducing tube was charged with bisphenol A ethylene oxide 2 mol adduct, bisphenol A propylene oxide 2 mol adduct, terephthalic acid, and adipic acid together with titanium tetraisopropoxide (1,000 ppm relative to the resin components) so that a molar ratio (OH/COOH) of the hydroxyl group to the carboxyl group was 1.1, the diol component was constituted with 80 mol % of bisphenol A ethylene oxide 2 mol adduct and 20 mol % of bisphenol A propylene oxide 2 mol adduct, and the dicarboxylic acid component was constituted with 60 mol % of terephthalic acid and 40 mol % of adipic acid. The obtained mixture was heated to 200° C. for about 4 hours, and was further heated to 230° C. for 2 hours. Then, the mixture was allowed to react until water was not discharged. Then, the mixture was further allowed to react under reduced pressure of from 10 mmHg through 15 mmHg for 5 hours, to obtain [intermediate polyester B-1].

Next, a reaction container equipped with a cooling tube, a stirrer, and a nitrogen-introducing tube was charged with the obtained [intermediate polyester B-1] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer B-1].

### Production Example B-2

<Synthesis of Prepolymer B-2 (Polyester Resin B-2)>

A reaction container equipped with a cooling tube, a stirrer, and a nitrogen-introducing tube was charged with bisphenol A ethylene oxide 2 mol adduct, bisphenol A propylene oxide 2 mol adduct, terephthalic acid, and adipic acid together with titanium tetraisopropoxide (1,000 ppm relative to the resin components) so that a molar ratio (OH/COOH) of the hydroxyl group to the carboxyl group was 1.1, the diol component was constituted with 80 mol % of bisphenol A ethylene oxide 2 mol adduct and 20 mol % of bisphenol A propylene oxide 2 mol adduct, and the dicarboxylic acid component was constituted with 30 mol % of terephthalic acid and 70 mol % of adipic acid. The obtained mixture was heated to 200° C. for about 4 hours, and was further heated to 230° C. for 2 hours. Then, the mixture was allowed to react until water was not discharged. Then, the mixture was further allowed to react under reduced pressure of from 10 mmHg through 15 mmHg for 5 hours, to obtain [intermediate polyester B-2].

Next, a reaction container equipped with a cooling tube, a stirrer, and a nitrogen-introducing tube was charged with the obtained [intermediate polyester B-2] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer B-2].

### Production Example B-3

<Synthesis of Prepolymer B-3 (Polyester Resin B-3)>

A reaction container equipped with a cooling tube, a stirrer, and a nitrogen-introducing tube was charged with bisphenol A ethylene oxide 2 mol adduct, bisphenol A propylene oxide 2 mol adduct, terephthalic acid, and adipic acid together with titanium tetraisopropoxide (1,000 ppm relative to the resin components) so that a molar ratio (OH/COOH) of the hydroxyl group to the carboxyl group was 1.1, the diol component was constituted with 80 mol % of bisphenol A ethylene oxide 2 mol adduct and 20 mol % of bisphenol A propylene oxide 2 mol adduct, and the dicarboxylic acid component was constituted with 80 mol % of terephthalic acid and 20 mol % of adipic acid. The obtained mixture was heated to 200° C. for about 4 hours, and was further heated to 230° C. for 2 hours. Then, the mixture was allowed to react until water was not discharged. Then, the mixture was further allowed to react under reduced pressure of from 10 mmHg through 15 mmHg for 5 hours, to obtain [intermediate polyester B-3].

Next, a reaction container equipped with a cooling tube, a stirrer, and a nitrogen-introducing tube was charged with the obtained [intermediate polyester B-3] and isophorone diisocyanate (IPDI) so that a molar ratio (the isocyanate group of IPDI/the hydroxyl group of the intermediate polyester) was 2.0. The obtained mixture was diluted with ethyl acetate so as to form a 50% ethyl acetate solution, and was allowed to react at 100° C. for 5 hours, to obtain [prepolymer B-3].

### Production Example C-1

<Synthesis of Polyester Resin C-1>

A four-neck flask equipped with a nitrogen-introducing tube, tube, a dehydrating tube, a stirrer, and a thermocouple was charged with bisphenol A ethylene oxide 2 mol adduct, bisphenol A propylene oxide 3 mol adduct, terephthalic acid, adipic acid, and trimethylolpropane so that a molar ratio (bisphenol A ethylene oxide 2 mol adduct/bisphenol A propylene oxide 3 mol adduct) of bisphenol A ethylene oxide 2 mol adduct to bisphenol A propylene oxide 3 mol adduct was 85/15, a molar ratio (terephthalic acid/adipic acid) of terephthalic acid to adipic acid was 75/25, an amount of trimethylolpropane in the whole monomer was 1 mol %, and a molar ratio (OH/COOH) of the hydroxyl group to the carboxyl group was 1.2. The mixture was allowed to react with titanium tetraisopropoxide (500 ppm relative to the resin components) under normal pressure at 230° C. for 8 hours, and was further allowed to react under reduced pressure of from 10 mmHg through 15 mmHg for 4 hours. Then, 1 mol % of trimellitic anhydride relative to the total resin components was charged into the reaction container, and was allowed to react at 180° C. under normal pressure for 3 hours, to obtain [polyester resin C-1].

### Production Example C-2

<Synthesis of Polyester Resin C-2>

A four-neck flask equipped with a nitrogen-introducing tube, a dehydrating tube, a stirrer, and a thermocouple was charged with bisphenol A ethylene oxide 2 mol adduct, bisphenol A propylene oxide 3 mol adduct, terephthalic acid, adipic acid, and trimethylolpropane so that a molar ratio (bisphenol A ethylene oxide 2 mol adduct/bisphenol A propylene oxide 3 mol adduct) of bisphenol A ethylene oxide 2 mol adduct to bisphenol A propylene oxide 3 mol adduct was 85/15, a molar ratio (terephthalic acid/adipic acid) of terephthalic acid to adipic acid was 65/35, an amount of trimethylolpropane in the whole monomer was 1 mol %, and a molar ratio (OH/COOH) of the hydroxyl group to the carboxyl group was 1.2. The mixture was allowed to react with titanium tetraisopropoxide (500 ppm relative to the resin components) under normal pressure at 230° C. for 8 hours, and was further allowed to react under reduced pressure of from 10 mmHg through 15 mmHg for 4 hours. Then, 1 mol % of trimellitic anhydride relative to the total resin components was charged into the reaction container, and was allowed to react at 180° C. under normal pressure for 3 hours, to obtain [polyester resin C-2].

### Production Example C-3

<Synthesis of Polyester Resin C-3>

A four-neck flask equipped with a nitrogen-introducing tube, a dehydrating tube, a stirrer, and a thermocouple was charged with bisphenol A ethylene oxide 2 mol adduct, bisphenol A propylene oxide 3 mol adduct, terephthalic acid, adipic acid, and trimethylolpropane so that a molar ratio (bisphenol A ethylene oxide 2 mol adduct/bisphenol A propylene oxide 3 mol adduct) of bisphenol A ethylene oxide 2 mol adduct to bisphenol A propylene oxide 3 mol adduct was 85/15, a molar ratio (terephthalic acid/adipic acid) of terephthalic acid to adipic acid was 85/15, an amount of trimethylolpropane in the whole monomer was 1 mol %, and a molar ratio (OH/COOH) of the hydroxyl group to the carboxyl group was 1.2. The mixture was allowed to react with titanium tetraisopropoxide (500 ppm relative to the resin components) under normal pressure at 230° C. for 8 hours, and was further allowed to react under reduced pressure of from 10 mmHg through 15 mmHg for 4 hours. Then, 1 mol % of trimellitic anhydride relative to the total resin components was charged into the reaction container, and was allowed to react at 180° C. under normal pressure for 3 hours, to obtain [polyester resin C-3].

### Production Example C-4

<Synthesis of Polyester Resin C-4>

A four-neck flask equipped with a nitrogen-introducing tube, a dehydrating tube, a stirrer, and a thermocouple was charged with bisphenol A ethylene oxide 2 mol adduct, bisphenol A propylene oxide 3 mol adduct, terephthalic acid, adipic acid, and trimethylolpropane so that a molar ratio (bisphenol A ethylene oxide 2 mol adduct/bisphenol A propylene oxide 3 mol adduct) of bisphenol A ethylene oxide 2 mol adduct to bisphenol A propylene oxide 3 mol adduct was 85/15, a molar ratio (terephthalic acid/adipic acid) of terephthalic acid to adipic acid was 60/40, an amount of trimethylolpropane in the whole monomer was 1 mol %, and a molar ratio (OH/COOH) of the hydroxyl group to the carboxyl group was 1.2. The mixture was allowed to react with titanium tetraisopropoxide (500 ppm relative to the resin components) under normal pressure at 230° C. for 8 hours, and was further allowed to react under reduced pressure of from 10 mmHg through 15 mmHg for 4 hours. Then, 1 mol % of trimellitic anhydride relative to the total resin components was charged into the reaction container, and was allowed to react at 180° C. under normal pressure for 3 hours, to obtain [polyester resin C-4].

### Production Example C-5

<Synthesis of Polyester Resin C-5>

A four-neck flask equipped with a nitrogen-introducing tube, a dehydrating tube, a stirrer, and a thermocouple was charged with bisphenol A ethylene oxide 2 mol adduct, bisphenol A propylene oxide 3 mol adduct, terephthalic acid, adipic acid, and trimethylolpropane so that a molar ratio (bisphenol A ethylene oxide 2 mol adduct/bisphenol A propylene oxide 3 mol adduct) of bisphenol A ethylene oxide 2 mol adduct to bisphenol A propylene oxide 3 mol adduct was 90/10, a molar ratio (terephthalic acid/adipic acid) of terephthalic acid to adipic acid was 75/25, an amount of trimethylolpropane in the whole monomer was 1 mol %, and a molar ratio (OH/COOH) of the hydroxyl group to the carboxyl group was 1.2. The mixture was allowed to react with titanium tetraisopropoxide (500 ppm relative to the resin components) under normal pressure at 230° C. for 8 hours, and was further allowed to react under reduced pressure of from 10 mmHg through 15 mmHg for 4 hours. Then, 1 mol % of trimellitic anhydride relative to the total resin components was charged into the reaction container, and was allowed to react at 180° C. under normal pressure for 3 hours, to obtain [polyester resin C-5].

### Example 1

<Preparation of Masterbatch (MB)>

Water (1,200 parts), carbon black (Printex 35, manufactured by Degussa) [DBP oil absorption amount=42 mL/100 mg, pH=9.5] (500 parts), and the [polyester resin C-1] (500 parts) were added and mixed using a Henschel mixer (manufactured by Mitsui Mining Co., Ltd.). The mixture was kneaded using a two-roll mill at 150° C. for 30 minutes. Then, the mixture was rolled and pulverized using a pulverizer, to obtain [masterbatch 1].

<Preparation of WAX Dispersion Liquid>

A container equipped with a stirring rod and a thermometer was charged with paraffin wax (50 parts) (manufactured by NIPPON SEIRO CO., LTD., HNP-9, hydrocarbon-based wax, melting point: 75° C., SP value: 8.8) as a release agent 1 and ethyl acetate (450 parts). The mixture was heated to 80° C. under stirring, and was maintained at 80° C. for 5 hours. Then, the mixture was cooled to 30° C. for an hour, and was dispersed using a bead mill (ULTRA VISCOMILL, manufactured by AIMEX CO., LTD.) under three passes at a liquid feed rate of 1 kg/h and a disk peripheral speed of 6 m/s with 80% by volume of zirconia beads having a diameter of 0.5 mm being loaded, to obtain [WAX dispersion liquid 1].

<Synthesis of Ketimine Compound>

Isophoronediamine (170 parts) and methyl ethyl ketone (75 parts) were charged into a reaction container equipped with a stirring rod and a thermometer, and were allowed to react at 50° C. for 5 hours, to obtain [ketimine compound 1]. The amine value of the [ketimine compound 1] was 418.

<Modified Layered Inorganic Mineral>

As a modified layered inorganic mineral, “CLAYTONE APA (manufactured by BYK-ChemieJapan)” was used.

<Preparation of Oil Phase>

The [WAX dispersion liquid 1] (500 parts), the [prepolymer A-1] (76 parts), the [prepolymer B-1] (152 parts), the [polyester resin C-1] (836 parts), the [masterbatch 1] (100 parts), the [ketimine compound 1] (2 parts) as a curing agent, and the [modified layered inorganic mineral] (1.2 parts) were charged into a container, and were mixed using a TK homomixer (manufactured by PRIMIX Corporation) at 5,000 rpm for 60 minutes, followed by additional dispersion using a bead mill. Then, the mixture was subjected to a homogenization step of performing homogenization, to obtain [oil phase 1].

<Synthesis of Organic Fine Particle Emulsion (Fine Particle Dispersion Liquid)>

Water (683 parts), a sodium salt of methacrylic acid ethylene oxide adduct sulfate ester (ELEMINOL RS-30: manufactured by Sanyo Chemical Industries, Ltd.) (11 parts), styrene (138 parts), methacrylic acid (138 parts), and ammonium persulfate (1 part) were charged into a reaction container equipped with a stirring rod and a thermometer, and were stirred at 400 rpm for 15 minutes, to obtain a white emulsion. The mixture was heated so that the system temperature reached 75° C., and was allowed to react for 5 hours. Moreover, a 1% ammonium persulfate aqueous solution (30 parts) was added thereto, and was aged at 75° C. for 5 hours, to obtain an aqueous dispersion liquid of a vinyl-based resin (a copolymer of styrene-methacrylic acid-sodium salt of methacrylic acid ethylene oxide adduct sulfate ester), [fine particle dispersion liquid 1].

The volume average particle diameter of the [fine particle dispersion liquid 1] measured using LA-920 (manufactured by HORIBA, Ltd.) was 14 μm. A part of the [fine particle dispersion liquid 1] was dried to isolate a resin component.

<Preparation of Aqueous Phase>

Water (990 parts), the [fine particle dispersion liquid 1] (83 parts), a 48.5% aqueous solution of sodium dodecyldiphenyl ether disulfonate (ELEMINOL MON-7: manufactured by Sanyo Chemical Industries, Ltd.) (37 parts), and ethyl acetate (90 parts) were mixed and stirred, to obtain a milky white liquid. This was referred to as [aqueous phase 1].

<Emulsification⋅Removal of Solvent>

To the container including the [oil phase 1], the [aqueous phase 1] (1,200 parts) was added, and was mixed using a TK homomixer at 13,000 rpm for 20 minutes, to obtain [emulsified slurry 1]. Next, a container equipped with a stirrer and a thermometer was charged with the [emulsified slurry 1], and the solvent was removed at 30° C. for 8 hours, followed by aging at 45° C. for 4 hours, to obtain [dispersion slurry 1].

<Washing⋅Drying>

After the [dispersion slurry 1] (100 parts) was filtered under reduced pressure, the following procedure was performed.

(1): Ion exchanged water (100 parts) was added to a filtration cake, and was mixed using a TK homomixer (at 12,000 rpm for 10 minutes), followed by filtration.

(2): A 10% sodium hydroxide aqueous solution (100 parts) was added to the filtration cake of (1), and was mixed using a TK homomixer (at 12,000 rpm for 30 minutes), followed by filtration under reduced pressure.

(3): To the filtration cake of (2), 10% hydrochloric acid (100 parts) was added and mixed using a TK homomixer (at 12,000 rpm for 10 minutes), followed by filtration.

(4): To the filtration cake of (3), ion exchanged water (300 parts) was added, and was mixed using a TK homomixer (at 12,000 rpm for 10 minutes), followed by filtration. The operation of (1) to (4) was repeated twice to obtain [filtration cake].

The [filtration cake] was dried at 45° C. for 48 hours using a circulating air dryer, and was then sieved using a mesh having an opening of 75 μm, to obtain [toner base particles 1].

<External Addition Treatment>

Hydrophobic silica having an average particle diameter of 100 nm (0.6 parts), titanium oxide having an average particle diameter of 20 nm (1.0 part), and hydrophobic silica fine powder having an average particle diameter of 15 nm (0.8 parts) relative to 100 parts of the [toner base particles 1] were mixed using a Henschel mixer, to obtain [toner 1].

<Preparation of Carrier>

To toluene (100 parts), silicone resin (organo straight silicone) (100 parts), γ-(2-aminoethyl)aminopropyltrimethoxysilane (5 parts), and carbon black (10 parts) were added and were dispersed using a homomixer for 20 minutes, to prepare a resin layer coating liquid. A fluidized bed-type coating apparatus was used to coat the resin layer coating liquid on the surface of spherical magnetite having an average particle diameter of 50 μm (1,000 parts), to prepare [carrier].

<Preparation of Developer>

A ball mill was used to mix the [toner 1] (5 parts) and the [carrier] (95 parts), to prepare a developer.

### Example 2

[Toner base particles 2] was obtained in the same manner as in Example 1 except that the [prepolymer A-1] was changed to the [prepolymer A-2] and the [polyester resin C-1] was changed to the [polyester resin C-2]. The [toner base particles 2] was used to prepare [toner 2].

### Example 3

[Toner base particles 3] was obtained in the same manner as in Example 1 except that the [prepolymer A-1] was changed to the [prepolymer A-2] and the [polyester resin C-1] was changed to the [polyester resin C-3]. The [toner base particles 3] was used to prepare [toner 3].

### Example 4

[Toner base particles 4] was obtained in the same manner as in Example 1 except that the [prepolymer A-1] was changed to the [prepolymer A-3] and the [polyester resin C-1] was changed to the [polyester resin C-2]. The [toner base particles 4] was used to prepare [toner 4].

### Example 5

[Toner base particles 5] was obtained in the same manner as in Example 1 except that the [prepolymer A-1] was changed to the [prepolymer A-3] (152 parts) and the [polyester resin C-1] was changed to the [polyester resin C-3] (798 parts). The [toner base particles 5] was used to prepare [toner 5].

### Example 6

[Toner base particles 6] was obtained in the same manner as in Example 1 except that the amount of the [prepolymer A-1] was changed to 134 parts, the amount of the [prepolymer B-1] was changed to 266 parts, and the amount of the [polyester resin C-1] was changed to 751 parts. The [toner base particles 6] was used to prepare [toner 6].

### Comparative Example 1

[Toner base particles 7] was obtained in the same manner as in Example 1 except that the [prepolymer A-1] was changed to the [prepolymer A-4], the [prepolymer B-1] was changed to the [prepolymer B-2], and the amount of the [modified layered inorganic mineral] was changed to 0.05 parts. The [toner base particles 7] was used to prepare [toner 7].

### Comparative Example 2

[Toner base particles 8] was obtained in the same manner as in Example 1 except that the [prepolymer A-1] was changed to the [prepolymer A-5], the [prepolymer B-1] was changed to the [prepolymer B-3], and the amount of the [modified layered inorganic mineral] was changed to 1.8 parts. The [toner base particles 8] was used to prepare [toner 8].

### Comparative Example 3

[Toner base particles 9] was obtained in the same manner as in Example 1 except that the homogenization step using a bead mill was omitted. The [toner base particles 9] was used to prepare [toner 9].

### Comparative Example 4

[Toner base particles 10] was obtained in the same manner as in Example 1 except that the [prepolymer B-1] was not added, and the [polyester resin C-1] was changed to the [polyester resin C-4]. The [toner base particles 10] was used to prepare [toner 10].

### Comparative Example 5

[Toner base particles 11] was obtained in the same manner as in Example 1 except that the [prepolymer A-1] was not added, and the [polyester resin C-1] was changed to the [polyester resin C-5]. The [toner base particles 11] was used to prepare [toner 11].

The formulation amounts (part(s) by mass) of the respective resin components and the modified layered inorganic mineral in the oil phase are presented in Table 1.

TABLE 1

| | | | | | | | | Modified | |
|---|---|---|---|---|---|---|---|---|---|
| | | | | | | | | layered | |
| | | Polyester | | Polyester | | Polyester | | inorganic | |
| | | resin A | | resin B | | resin C | | mineral | |
| | Toner | Prepolymer | Parts | Prepolymer | Parts | Resin | Parts | Parts | |
| | Nos. | kind | by mass | kind | by mass | kind | by mass | by mass | Remarks |
| Ex. 1 | 1 | A-1 | 76 | B-1 | 152 | C-1 | 836 | 1.2 | |
| Ex. 2 | 2 | A-2 | 76 | B-1 | 152 | C-2 | 836 | 1.2 | |
| Ex. 3 | 3 | A-2 | 76 | B-1 | 152 | C-3 | 836 | 1.2 | |
| Ex. 4 | 4 | A-3 | 76 | B-1 | 152 | C-2 | 836 | 1.2 | |
| Ex. 5 | 5 | A-3 | 152 | B-1 | 152 | C-3 | 798 | 1.2 | |
| Ex. 6 | 6 | A-1 | 134 | B-1 | 266 | C-1 | 751 | 1.2 | |
| Comp. | 7 | A-4 | 76 | B-2 | 152 | C-1 | 836 | 0.05 | |
| Ex. 1 | | | | | | | | | |
| Comp. | 8 | A-5 | 76 | B-3 | 152 | C-1 | 836 | 1.8 | |
| Ex. 2 | | | | | | | | | |
| Comp. | 9 | A-1 | 76 | B-1 | 152 | C-1 | 836 | 1.2 | NO |
| Ex. 3 | | | | | | | | | homogenization |
| | | | | | | | | | step |
| Comp. | 10 | A-1 | 76 | — | — | C-4 | 836 | 1.2 | |
| Ex. 4 | | | | | | | | | |
| Comp. | 11 | — | — | B-1 | 152 | C-5 | 836 | 1.2 | |
| Ex. 5 | | | | | | | | | |

(Measurement)

<Toner Tg1st, and Glass Transition Temperatures of Polyester Resins A, B, and C>

The toner (1 g) was added to THF (100 mL), and the mixture was subjected to Soxhlet extraction, to obtain a THF-soluble component and a THF-insoluble component. These components were dried in a vacuum dryer for 24 hours, to obtain the polyester resin C from the THF-soluble component and a mixture of the polyester resin A and the polyester resin B from the THF-insoluble component.

These components were used as target samples. In addition, in order to measure the toner Tg1st, the toner was used as a target sample.

Next, a target sample (about 5.0 mg) was charged into a sample container made of aluminum, the sample container was placed on a holder unit, and was set in an electric furnace. Next, under nitrogen atmosphere, the mixture was heated from −80° C. to 150° C. at a heating rate of 10° C./min (first temperature rise). Then, the mixture was cooled from 150° C. to −80° C. at a cooling rate of 10° C./min, and was further heated to 150° C. at a heating rate of 10° C./min (second temperature rise). In each of the first temperature rise and the second temperature rise, a differential scanning calorimeter (“Q-200”, manufactured by TA Instruments) was used to measure a DSC curve.

The analysis program in the Q-200 system was used to select the DSC curve at the first temperature rise from the obtained DSC curves, to determine the glass transition temperature Tg1st at the first temperature rise of the target sample. Similarly, the DSC curve at the second temperature rise was selected, to determine the glass transition temperature Tg2nd at the second temperature rise of the target sample.

The toner was subjected to Soxhlet extraction, to obtain a THF-soluble component and a THF-insoluble component. These components were dried in a vacuum dryer for 24 hours, to obtain a mixture (1) of the polyester resin C and the crystalline polyester resin from the THF-soluble component. From the THF-insoluble component, a mixture (2) of the polyester resin A and the polyester resin B was obtained.

Regarding the mixture (1), the mass of the obtained mixture (1) and the mass of the obtained mixture (2) were measured, and the mass ratio of the mixture (1) to the total amount was calculated, thereby obtaining the mass ratio between the polyester resin C and the crystalline polyester resin.

Regarding the mixture (2), the mass of the obtained mixture (1) and the mass of the obtained mixture (2) were measured, and the mass ratio of the mixture (2) to the total amount was calculated, thereby obtaining the mass ratio of the polyester resin A+the polyester resin B.

The composition ratio, the Tg1st, and the Tg2nd of the toners and the glass transition temperatures of the polyester resins A, B, and C were presented in Table 2-1 and Table 2-2.

TABLE 2-1

| | | | | | | | | | | | Modified |
|---|---|---|---|---|---|---|---|---|---|---|---|
| | | Polyester | | | Polyester | | | Polyester | | | layered |
| | | resin A | | | resin B | | | resin C | | | inorganic |
| | Homogenization | | | Mass | | | Mass | | | Mass | mineral |
| | step | Kind | Tg (° C.) | ratio | Kind | Tg (° C.) | ratio | Kind | Tg (° C.) | ratio | (parts by mass) |
| Ex. 1 | Done | A-1 | −40 | 0.04 | B-1 | 55 | 0.08 | C-1 | 55 | 0.88 | 1.2 |
| Ex. 2 | Done | A-2 | −50 | 0.04 | B-1 | 55 | 0.08 | C-2 | 45 | 0.88 | 1.2 |
| Ex. 3 | Done | A-2 | −50 | 0.04 | B-1 | 55 | 0.08 | C-3 | 65 | 0.88 | 1.2 |
| Ex. 4 | Done | A-3 | 0 | 0.04 | B-1 | 55 | 0.08 | C-2 | 45 | 0.88 | 1.2 |
| Ex. 5 | Done | A-3 | 0 | 0.08 | B-1 | 55 | 0.08 | C-3 | 65 | 0.84 | 1.2 |
| Ex. 6 | Done | A-1 | −40 | 0.07 | B-1 | 55 | 0.14 | C-1 | 55 | 0.79 | 1.2 |
| Comp. | Done | A-4 | −55 | 0.04 | B-2 | 45 | 0.08 | C-1 | 55 | 0.88 | 0.05 |
| Ex. 1 | | | | | | | | | | | |
| Comp. | Done | A-5 | 5 | 0.04 | B-3 | 65 | 0.08 | C-1 | 55 | 0.88 | 1.8 |
| Ex. 2 | | | | | | | | | | | |
| Comp. | Not done | A-1 | −40 | 0.04 | B-1 | 55 | 0.08 | C-1 | 55 | 0.88 | 1.2 |
| Ex. 3 | | | | | | | | | | | |
| Comp. | Done | A-1 | −40 | 0.04 | — | — | — | C-4 | 40 | 0.88 | 1.2 |
| Ex. 4 | | | | | | | | | | | |
| Comp. | Done | — | — | — | B-1 | 55 | 0.08 | C-5 | 70 | 0.88 | 1.2 |
| Ex. 5 | | | | | | | | | | | |

TABLE 2-2

| | Release | | Curing | | | | | | Liberation |
|---|---|---|---|---|---|---|---|---|---|
| | agent | Pigment | agent | | | | | | ratio of |
| | (parts by | (parts by | (parts by | Tga1st | Tgb1st | Tg1st | Tg2nd | Tg1st − | silica |
| | mass) | mass) | mass) | (° C.) | (° C.) | (° C.) | (° C.) | Tg2nd | [%] |
| Ex. 1 | 50 | 50 | 2 | −37 | 57 | 57 | 45 | 12 | 0.95 |
| Ex. 2 | 50 | 50 | 2 | −40 | 57 | 53 | 42 | 11 | 0.86 |
| Ex. 3 | 50 | 50 | 2 | −40 | 57 | 58 | 46 | 12 | 0.92 |
| Ex. 4 | 50 | 50 | 2 | 3 | 57 | 60 | 46 | 14 | 0.91 |
| Ex. 5 | 50 | 50 | 2 | 3 | 57 | 60 | 50 | 10 | 0.89 |
| Ex. 6 | 50 | 50 | 2 | −37 | 57 | 57 | 45 | 12 | 0.75 |
| Comp. | 50 | 50 | 2 | −50 | 57 | 57 | 45 | 12 | 0.48 |
| Ex. 1 | | | | | | | | | |
| Comp. | 50 | 50 | 2 | 10 | 57 | 60 | 52 | 8 | 1.10 |
| Ex. 2 | | | | | | | | | |
| Comp. | 50 | 50 | 2 | −37 | 57 | 55 | 44 | 11 | 0.45 |
| Ex. 3 | | | | | | | | | |
| Comp. | 50 | 50 | 2 | −37 | — | 50 | 40 | 10 | 0.62 |
| Ex. 4 | | | | | | | | | |
| Comp. | 50 | 50 | 2 | — | 57 | 65 | 58 | 7 | 0.63 |
| Ex. 5 | | | | | | | | | |

(Evaluation)

The toners and the developers obtained above were evaluated in the following manners. Note that, the developers were produced in the same manner as in Example 1.

<Evaluation of Low-Temperature Fixability on Normal Paper>

The developer was loaded into the image forming apparatus illustrated in FIG. 2. A rectangular solid image having a size of 2 cm×15 cm was formed on PPC sheet (TYPE 6000 <70W>, A4, grain long paper (manufactured by RICOH COMPANY, LTD.)) in the monochrome mode so as to have a toner deposition amount of 0.40 mg/cm². At this time, the surface temperature of the fixing roller was changed, and presence or absence of offset, in which the remaining developed image of the solid image was fixed on a portion other than a desired portion, was observed. Then, fixing temperatures at which cold offset and hot offset occur were evaluated. The solid image was formed on the transfer paper at a position 3.0 cm from the leading edge in the paper feeding direction. The speed of passing through the nip portion of the fixing device was 300 mm/s.

[Evaluation Criteria for Cold Offset]

A: The fixing lower limit temperature was 130° C. or less.

B: The fixing lower limit temperature was more than 130° C. and 135° C. or less.

C: The fixing lower limit temperature was more than 135° C. and 140° C. or less.

D: The fixing lower limit temperature was more than 140° C.

<Heat-Resistant Storage Stability>

After the toner was stored at 50° C. for 8 hours, it was sieved with a 42-mesh sieve for 2 minutes, and the residual ratio on the mesh was measured. At this time, the better the heat-resistant storage stability of the toner, the smaller the residual ratio. The evaluation criteria of the heat-resistant storage stability were as follows.

[Evaluation Criteria]

A: The residual ratio was less than 5%.

B: The residual ratio was 5% or more and less than 15%.

C: The residual ratio was 15% or more and less than 30%.

D: The residual ratio was 30% or more.

<Cleanability>

The image forming apparatus was used to output charts having an image area ratio of 5% on 50,000 sheets (A4 size, horizontal) at 3 prints/job in a lab environment of 21° C. and 65% RH, and 50,000 sheets of paper were allowed to pass in the following manner.

Then, 100 sheets of evaluation images with three charts of vertical band patterns having a width of 43 mm (with respect to a direction in which paper is fed) (A4 size, horizontal) were output in a lab environment of 32° C. and 54% RH. The obtained images were visually observed, and the cleanability was evaluated based on presence or absence of an abnormal image due to poor cleanability.

[Evaluation Criteria]

A: The toner that had slipped due to cleaning failure was visually observed neither on print paper nor on a photoconductor, and stripe-shaped marks of the toner that had slipped were not found even when the photoconductor was observed in a longitudinal direction with a microscope.

B: The toner that had slipped due to cleaning failure was visually observed neither on print paper nor on a photoconductor, but stripe-shaped marks of the toner that had slipped were found when the photoconductor was observed in a longitudinal direction with a microscope.

D: The toner that had slipped due to cleaning failure was visually found both on print paper and on a photoconductor.

<Evaluation of Image Roughness>

A carrier and a toner used in imagio MP C4300 (manufactured by RICOH COMPANY, LTD.) were mixed so that the concentration of the toner was 5% by mass, to obtain a developer. The developer was loaded into imagio MP C4300 (manufactured by RICOH COMPANY, LTD.), and 250 sheets of documents (A4 size) having an image area ratio of 25% were continuously printed in monochrome color. Each of the images was evaluated based on the evaluation ranks of image roughness. Note that, the image roughness was evaluated based on the uniformity of the halftone portion.

[Evaluation Criteria]

A: No roughness was found at all and a good image was obtained.

B: Roughness was slightly found, but a relatively good image was obtained.

C: Roughness was slightly found, but image quality in an acceptable range was obtained.

D: Roughness was found, and image quality falling below the acceptable limit was obtained (unacceptable).

<Filming of Additive>

The image forming apparatus was used to output charts having an image area ratio of 30% on 5,000 sheets (A4 size, horizontal) at 3 prints/job in a lab environment of 27° C. and 90% RH, and 5,000 blank sheets (A4 size, horizontal) were output at 3 prints/job. Then, after a halftone image was printed on one sheet, the photoconductor was visually observed.

[Evaluation Criteria]

A: No defect was found on the photoconductor. No problem in quality was found.

B: Slight filming was found in the print direction, but was not at a problematic level because the image had no problem in quality.

D: Filming was apparent on the photoconductor, and was at a problematic level in terms of image quality.

TABLE 3

| | | Heat- | | | |
|---|---|---|---|---|---|
| | Low | resistance | | | Filming |
| | temperature | storage | | | of |
| | fixability | stability | Cleanability | Roughness | additive |
| Ex. 1 | A | A | A | A | A |
| Ex. 2 | A | C | B | B | B |
| Ex. 3 | A | B | B | B | B |
| Ex. 4 | C | A | B | B | B |
| Ex. 5 | C | A | B | B | B |
| Ex. 6 | A | C | B | B | B |
| Comp. | A | D | D | C | B |
| Ex. 1 | | | | | |
| Comp. | D | B | B | C | D |
| Ex. 2 | | | | | |
| Comp. | B | C | D | B | B |
| Ex. 3 | | | | | |
| Comp. | B | D | C | C | B |
| Ex. 4 | | | | | |
| Comp. | D | C | D | B | D |
| Ex. 5 | | | | | |

The present disclosure relates to the tonner according to (1) below, and includes the following (2) to (16) as embodiments.

(1)

A toner for developing an electrostatic charge image, the toner including:
a toner base; and
an external additive containing silica,
wherein the toner base includes at least a binder resin, a colorant, a release agent, and a modified layered inorganic mineral, the modified layered inorganic mineral being obtained by modifying, with an organic ion, at least part of ions between layers in a layered inorganic mineral,
an amount of the modified layered inorganic mineral is 0.1 parts by mass or more and less than 1.4 parts by mass relative to 100 parts by mass of the toner, and a liberation ratio A of silica from the toner, represented by % by mass, satisfies a relation (1) below:

0.5≤A≤1.0 relation (1)
the binder resin includes a component insoluble in tetrahydrofuran (THF) and a component soluble in THF,
the component insoluble in THF has two glass transition temperatures of Tga1st and Tgb1st at a first temperature rise in differential scanning calorimetry (DSC), the Tga1st is −40° C. or more and 10° C. or less, and the Tgb1st is 45° C. or more and 65° C. or less.

(2)

The toner according to (1),
wherein the toner is a black toner.

(3)

The toner according to (1) or (2),
wherein the component insoluble in THF of the toner has a glass transition temperature (Tgab2nd) of 0° C. or more and 50° C. or less at a second temperature rise in the DSC.

(4)

The toner according to any one of (1) to (3),
wherein the toner has a glass transition temperature (Tg1st) at a first temperature rise in the DSC and a glass transition temperature (Tg2nd) at a second temperature rise in the DSC, and the glass transition temperature (Tg1st) and the glass transition temperature (Tg2nd) satisfy a formula (3) below,

Tg1st−Tg2nd≥10 [° C.] formula (3).

(5)

The toner according to any one of (1) to (4),
wherein the component insoluble in THF of the toner includes a polyester resin A and a polyester resin B, the polyester resin A having a glass transition temperature (Tga2nd) of −50° C. or more and 0° C. or less at a second temperature rise in the DSC, and the polyester resin B having a glass transition temperature (Tgb2nd) of 45° C. or more and 65° C. or less at a second temperature rise in the DSC, and
the component soluble in THF of the toner includes a polyester resin C, the polyester resin C having a glass transition temperature (Tgc2nd) of 45° C. or more and 65° C. or less at a second temperature rise in the DSC.

(6)

The toner according to (5),
wherein a relation (2) below is true:

4(a+b)<c relation (2),
where the a is a mass ratio of the polyester resin A, the b is a mass ratio of the polyester resin B, and the c is a mass ratio of the polyester resin C, each of the mass ratios being relative to a total mass of the polyester resin A, the polyester resin B, and the polyester resin C.

(7)

The toner according to (5) or (6),
wherein the polyester resin A includes an aliphatic polyhydric alcohol component that is trihydric or tetrahydric and has from 3 through 10 carbon atoms.

(8)

The toner according to any one of (5) to (7)
wherein the polyester resin A includes a diol component, and
the diol component includes: a portion to be a main chain, the portion having an odd number of carbon atoms ranging from 3 to 9; and an alkyl group at a side chain.

(9)

The toner according to any one of (5) to (8)
wherein the polyester resin A includes either or both of a urethane bond and a urea bond.

(10)

The toner according to any one of (5) to (9)
wherein the polyester resin B includes either or both of a urethane bond and a urea bond.

(11)

The toner according to any one of (5) to (10),
wherein the polyester resin C includes an aliphatic polyhydric alcohol component that is trihydric or tetrahydric and has from 3 through 10 carbon atoms.

(12)

A toner-storing unit including:
a unit; and
the toner of any one of (1) to (11) stored in the unit.

(13)

A developer including:
the toner of any one of (1) to (11); and
a carrier.

(14)

An image forming apparatus including;
an electrostatic latent image bearer;
an electrostatic latent image forming unit configured to form an electrostatic latent image on the electrostatic latent image bearer; and
a developing unit that includes the toner of any one of (1) to (11) and is configured to develop, with the toner, the electrostatic latent image formed on the electrostatic latent image bearer, to form a visible image.

(15)

The image forming apparatus according to (14),
wherein a linear velocity of the electrostatic latent image bearer is 300 mm/s or more.

(16)

An image forming method including:
forming an electrostatic latent image on an electrostatic latent image bearer; and
developing the electrostatic latent image formed on the electrostatic latent image bearer with the toner of any one of (1) to (11), to form a toner image.

Further, the present invention is not limited to these embodiments, but various variations and modifications may be made without departing from the scope of the present invention.

What is claimed is:

1. A toner for developing an electrostatic charge image, the toner comprising:
a toner base; and
an external additive containing silica,
wherein the toner base includes at least a binder resin, a colorant, a release agent, and a modified layered inorganic mineral, the modified layered inorganic mineral being obtained by modifying, with an organic ion, at least part of ions between layers in a layered inorganic mineral,
an amount of the modified layered inorganic mineral is 0.1 parts by mass or more and less than 1.4 parts by mass relative to 100 parts by mass of the toner, and a liberation ratio A of silica from the toner, represented by % by mass, satisfies a relation (1) below:
0.5≤A≤1.0 relation (1)
the binder resin includes a component insoluble in tetrahydrofuran (THF) and a component soluble in THF,
the component insoluble in THF has two glass transition temperatures of Tga1st and Tgb1st at a first temperature rise in differential scanning calorimetry (DSC), the Tga1st is −40° C. or more and 10° C. or less, and the Tgb1st is 45° C. or more and 65° C. or less.

2. The toner according to claim 1,
wherein the toner is a black toner.

3. The toner according to claim 1,
wherein the component insoluble in THF of the toner has a glass transition temperature (Tgab2nd) of 0° C. or more and 50° C. or less at a second temperature rise in the DSC.

4. The toner according to claim 1,
wherein the toner has a glass transition temperature (Tg1st) at a first temperature rise in the DSC and a glass transition temperature (Tg2nd) at a second temperature rise in the DSC, and the glass transition temperature (Tg1st) and the glass transition temperature (Tg2nd) satisfy a formula (3) below,
Tg1st−Tg2nd≥10 [° C.] formula (3).

5. The toner according to claim 1,
wherein the component insoluble in THF of the toner includes a polyester resin A and a polyester resin B, the polyester resin A having a glass transition temperature (Tga2nd) of −50° C. or more and 0° C. or less at a second temperature rise in the DSC, and the polyester resin B having a glass transition temperature (Tgb2nd) of 45° C. or more and 65° C. or less at a second temperature rise in the DSC, and
the component soluble in THF of the toner includes a polyester resin C, the polyester resin C having a glass transition temperature (Tgc2nd) of 45° C. or more and 65° C. or less at a second temperature rise in the DSC.

6. The toner according to claim 5,
wherein a relation (2) below is true:
4(a+b)<c relation (2),
where the a is a mass ratio of the polyester resin A, the b is a mass ratio of the polyester resin B, and the c is a mass ratio of the polyester resin C, each of the mass ratios being relative to a total mass of the polyester resin A, the polyester resin B, and the polyester resin C.

7. The toner according to claim 5,
wherein the polyester resin A includes an aliphatic polyhydric alcohol component that is trihydric or tetrahydric and has from 3 through 10 carbon atoms.

8. The toner according to claim 5,
wherein the polyester resin A includes a diol component, and
the diol component includes: a portion to be a main chain, the portion having an odd number of carbon atoms ranging from 3 to 9; and an alkyl group at a side chain.

9. The toner according to claim 5,
wherein the polyester resin A includes either or both of a urethane bond and a urea bond.

10. The toner according to claim 5,
wherein the polyester resin B includes either or both of a urethane bond and a urea bond.

11. The toner according to claim 5,
wherein the polyester resin C includes an aliphatic polyhydric alcohol component that is trihydric or tetrahydric and has from 3 through 10 carbon atoms.

12. A toner-storing unit, comprising:
a unit; and
the toner of claim 1 stored in the unit.

13. A developer, comprising:
the toner of claim 1; and
a carrier.

14. An image forming apparatus, comprising:
an electrostatic latent image bearer;
an electrostatic latent image forming unit configured to form an electrostatic latent image on the electrostatic latent image bearer; and
a developing unit that includes the toner of claim 1 and is configured to develop, with the toner, the electrostatic latent image formed on the electrostatic latent image bearer, to form a visible image.

15. The image forming apparatus according to claim 14,
wherein a linear velocity of the electrostatic latent image bearer is 300 mm/s or more.

16. An image forming method, comprising:
forming an electrostatic latent image on an electrostatic latent image bearer; and
developing the electrostatic latent image formed on the electrostatic latent image bearer with the toner of claim 1, to form a toner image.
